(19) United States
(12) Patent Application Publication
(10) Pub. No.: US 2025/0073670 A1
(43) Pub. Date: Mar. 6, 2025

(54) HYGROSCOPIC POLYMER COMPOSITES AND RELATED MANUFACTURING METHODS

(71) Applicant: Arizona Board of Regents on behalf of Arizona State University, Scottsdale, AZ (US)

(72) Inventors: Cody Friesen, Fort McDowell, AZ (US); Jose Antonio Bautista-Martinez, Mesa, AZ (US); Mykhaylo Goncharenko, Scottsdale, AZ (US); Paul Johnson, Phoenix, AZ (US)

(73) Assignee: Arizona Board of Regents on behalf of Arizona State University, Scottsdale, AZ (US)

(21) Appl. No.: 18/811,439

(22) Filed: Aug. 21, 2024

Related U.S. Application Data
(60) Provisional application No. 63/535,339, filed on Aug. 30, 2023.

(51) Int. Cl. B01J 20/26; B01J 20/24; B01J 20/28; B01J 20/34; C09K 5/04; H02S 40/42

(52) U.S. Cl. CPC B01J 20/261; B01J 20/24; B01J 20/28026; B01J 20/28045; B01J 20/3425; B01J 20/3483; C09K 5/048; H02S 40/425

(57) ABSTRACT

This disclosure is related to materials with highly stable and reversible water sorption and retention properties, as well as formulations and methods for their manufacture and uses. Composite materials of the present disclosure can avoid weeping or leakage of liquid water at wide ranges in ambient relative humidities so as to be suitable for a variety of applications including thermal management, thermal energy storage, atmospheric water generation and dehumidification systems. Composites disclosed herein can comprise an ionomeric material and in some embodiments, a hygroscopic or deliquescent salt. Furthermore, composites disclosed herein can also include a water vapor permeable or support polymer material providing support for reversible expansion or volume changes during water vapor sorption/desorption cycling via porous and/or elastic character, thereby avoiding mechanical restriction that could cause weeping or leakage of liquid water.

### CROSS-REFERENCE TO RELATED APPLICATION

This application claims priority to U.S. Provisional Application Ser. No. 63/535,339, filed on Aug. 30, 2023, the disclosure of which is incorporated by reference in its entirety.

### TECHNICAL FIELD

This disclosure is related to materials with highly stable and reversible water sorption and retention properties, as well as formulations and methods for their manufacture and uses. The composite materials of the present disclosure are suitable for a variety of applications including thermal management, thermal energy storage, atmospheric water generation and dehumidification systems.

### BACKGROUND

Various types of sorbent materials capable of water vapor sorption exist including hygroscopic or deliquescent salts, fibrous materials like cellulose, zeolites, silica, hydrogels and metal-organic frameworks (MOFs). Sorbent materials can be used in many types of devices and applications such as thermal management, thermal energy storage, atmospheric water generation and dehumidification systems which have critical demands in sorbent material performance relating to hygroscopic capacity (e.g., high water vapor uptake without weeping or leakage of liquid water), highly stable and reversible cycling (e.g., fast sorption kinetics, low desorption enthalpy) as well as being scalable and low cost.

There exists a need for improved sorbent materials having stable performance for both established and entirely new applications needing highly reversible and stable water sorption behavior, effective thermal properties, robust mechanical strength and/or other properties based on a particular application.

### BRIEF SUMMARY

According to one or more implementations of the present disclosure, a hygroscopic polymer composite comprises an ionomeric material having an ionized polymeric matrix to retain an equilibrated water content and a water vapor permeable polymer material to support a volume change of the ionomeric material between a contracted state having a first equilibrated water content and a swelled state having a second equilibrated water content, the second equilibrated water content being greater than the first equilibrated water content. In some implementations, a composite can further comprise a hygroscopic or deliquescent salt incorporated within an ionized polymeric matrix of the ionomeric material. Furthermore, various implementations include a reinforcement material to support a volume change of the ionomeric material or both the ionic material and the water vapor permeable polymer material between the contracted state and the swelled state.

In various implementations of the present disclosure, a method of manufacturing a hygroscopic polymer composite can comprise preparing an ionomeric material and a water vapor permeable polymer material to support the ionomeric material and hygroscopic or deliquescent salt, if present.

The materials and methods of the present disclosure are suitable for a variety of applications including thermal management, thermal energy storage, atmospheric water generation and dehumidification systems. In one or more implementations, a hygroscopic polymer composite is formed as a layer to receive heat from a surface, such as generated by a solar panel during a daytime operation, such that water is evaporated from the hygroscopic polymer composite to the ambient environment upon transition from the swelled state to the contracted state.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. Views in the figures are drawn to scale (unless otherwise noted), meaning the sizes of the depicted elements are accurate relative to each other for at least the embodiment in the view.

FIG. 1A depicts an illustration of a hygroscopic polymer composite including an ionomeric material and a water vapor permeable support polymer material having a porous matrix facilitating water vapor permeation while providing a semi-rigid or rigid framework to support the volume change of the ionomeric material between a contracted state and a swelled state;

FIG. 1B depicts an illustration of a hygroscopic polymer composite including an ionomeric material and a water vapor permeable polymer material exhibiting an elastic volume change between the contracted state and the swelled state;

FIG. 2A depicts an illustration of a hygroscopic polymer composite including a hygroscopic salt incorporated into a polymeric matrix of an ionomeric material;

FIG. 2B depicts an illustration of a hygroscopic polymer composite comprising an ionomeric material within water vapor permeable polymer material dispersed or supported in a reinforcing fiber material;

FIG. 3A depicts the chemical structure of a polydiallyldimethylammonium chloride (poly-DADMAC) ionomeric material;

FIG. 3B depicts the chemical structure of a hydroxy-functionalized poly-DADMAC ionomeric material, specifically dihydroxymethyl functionalized poly-DADMAC;

FIG. 3C depicts the chemical structure of a hydroxy aminium functionalized poly-DADMAC ionomeric material, specifically 2-hydroxyethyl-N,N-dimethylaminiummethyl functionalized poly-DADMAC;

FIG. 4 depicts synthesis of poly-DADMAC (shown in FIG. 3A) via polymerization of a diallyldimethylammonium chloride (DADMAC) monomer and a piperazinium crosslinker;

FIG. 5 depicts synthesis of a poly-DADMAC ionomeric material via polymerization of diallyl dimethyl ammonium chloride (DADMAC) monomer and a tetraallylammonium crosslinker;

FIG. 6A depicts synthesis of a long chain tetraallyl-substituted dihydroxy diaminium crosslinker from diallylamine and N,N′-bis(oxiranylmethyl)-N,N,N′,N′-tetramethyl-1,6-hexanediaminium dichloride;

FIG. 6B depicts the chemical structure of a hydroxy aminium functionalized poly-DADMAC ionomeric material, specifically 2-hydroxyethyl-N,N-dimethylaminiummethyl functionalized poly-DADAMAC including a hydroxy diaminium long chain crosslinker;

FIG. 7A is an example of a typical NMR spectra of a hydroxymethyl DADMAC monomer, specifically diallyldiethanolammonium chloride;

FIG. 7B is an example of a typical NMR spectra of a piperazinium crosslinker, specifically 1,1,4,4-tetraallylpiperazinium dichloride;

FIG. 8A depicts an aminium functionalized chitosan ionomeric material;

FIG. 8B depicts a diaminium diepoxide crosslinker, specifically N,N′-bis(oxiranylmethyl)-N,N,N′,N′-tetramethyl-1,6-hexanediaminium dichloride crosslinker;

FIG. 8C depicts the chemical structure of a crosslinked hydroxy aminium functionalized chitosan ionomeric material;

FIG. 9A shows a photograph of a hygroscopic polymer composite body comprising a functionalized chitosan-based ionomeric material and a polyisocyanurate-based water vapor permeable support polymer material;

FIG. 9B shows a photograph of a hygroscopic polymer composite body comprising a poly-DADMAC-based ionomeric material, a polyisocyanurate-based water vapor permeable support polymer material and a hygroscopic salt;

FIG. 9C shows a photograph of a hygroscopic polymer composite body comprising a poly-DADMAC-based ionomeric material, a polyisocyanurate-based water vapor permeable support polymer material and a hygroscopic salt;

FIG. 9D shows a photograph of a hygroscopic polymer composite body comprising a poly-DADMAC-based ionomeric material, a polyisocyanurate-based water vapor permeable support polymer material and a hygroscopic salt;

FIG. 10 depicts of a magnified photograph of a hygroscopic polymer composite body comprising a functionalized chitosan-based ionomeric material and a polyisocyanurate-based water vapor permeable support polymer material;

FIG. 11 shows water sorption isotherm plots for A) a poly-DADMAC ionomeric material and B) a poly-DADMAC ionomeric material incorporating 80 wt. % calcium chloride;

FIG. 12 shows reversible water vapor sorption cycling at 60% RH and 25° C. for (A) a hygroscopic polymer composite, (B) an ionomeric material and, (C) a water vapor permeable support polymer;

FIG. 13A shows water vapor sorption or water uptake at 60% RH and 25° C. for a hygroscopic polymer composite comprising (A) 20 weight % (wt. %) water vapor permeable support polymer and (B) 30 weight % (wt. %) water vapor permeable support polymer;

FIG. 13B shows water vapor sorption or water uptake at 60% RH and 25° C. for a hygroscopic polymer composite (A) with a hygroscopic salt and (B) in the absence of the hygroscopic salt;

FIG. 13C shows water vapor sorption or water uptake at 60% RH and 25° C. for a hygroscopic polymer composite (A) with 20 wt. % water vapor permeable support polymer and 60 wt. % hygroscopic salt and (B) with 40 wt. % water vapor permeable support polymer and 40 wt. % hygroscopic salt;

FIG. 14A illustrates a cross-sectional view of a solar panel comprising a hygroscopic polymer composite layer or coating;

FIG. 14B illustrates a cross-sectional view of a solar panel comprising a multilayer hygroscopic polymer composite;

FIG. 15A shows a photograph of a hygroscopic polymer composite formed as a layer for application to a rear surface of a solar cell or panel;

FIG. 15B depicts of a magnified photograph of a hygroscopic polymer composite body comprising a poly-DADMAC-based ionomeric material and a PEBA-based water vapor permeable polymer material;

FIG. 16 shows power output for a solar cell (A) comprising a hygroscopic polymer composite adhered to its rear surface compared to a similar solar cell (B) without any rear side polymer composite layer;

FIG. 17 illustrates a perspective cross-sectional view of a water generation system comprising a hygroscopic polymer composite;

FIG. 18 depicts a method for manufacturing a hygroscopic polymer composite.

For simplicity and clarity of illustration, the drawing figures show the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

### DESCRIPTION OF ILLUSTRATIVE EMBODIMENTS

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that logical, chemical, and mechanical changes may be made without departing from the spirit and scope of the disclosure.

Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full, and/or any other possible attachment option. Surface shading lines may be used throughout the figures to denote different parts but not necessarily to denote the same or different materials.

This disclosure includes embodiments of various materials, systems and methods. The term “coupled” is defined as connected, although not necessarily directly, and not necessarily mechanically. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately” and “about” may be substituted with “within [a percentage] of” what is specified, where the percentage includes 0.1, 1, 5, and 10%. Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements, but is not limited to possessing only those elements. Likewise, a method that “comprises,” “has,” “includes,” or “contains” one or more operations or steps possesses those one or more operations or steps, but is not limited to possessing only those one or more operations or steps.

Any embodiment of any of the materials, compositions, apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. The feature or features of one embodiment may be applied to other embodiments or implementations, even though not described or illustrated, unless expressly prohibited by this disclosure or the nature of the embodiments.

This disclosure is directed to a new class of hygroscopic polymer composites having distinctive water vapor sorption/desorption properties that facilitate stable performance without weeping (i.e., liquid water loss from the material) across a range of ambient conditions. These composites can be used in a range of devices and applications including thermal management systems, thermal energy storage systems, passive cooling applications, humidity regulation systems, air conditioning systems, waste heat recovery systems, atmospheric water generation systems, and dehumidification systems. The materials and compositions of the present technology can be deployed in both established and entirely new applications that may benefit from high hygroscopic capacity, reversible water sorption cycling characteristics, effective thermal properties via latent heat of vaporization and/or high mechanical stability at high water contents. As such, this new class of hygroscopic polymer composites can meet the needs of many systems and processes that can address various challenges like water scarcity and poor energy efficiency.

The term “hygroscopic” is used herein to refer to a characteristic property of attracting and holding water molecules via absorption and/or adsorption from the surrounding environment as well as ability to reversibly release captured water as water vapor (e.g., via a temperature variation, humidity variation, pressure variation, and/or the like). The composites or materials of the present technology can comprise various components or constituents in a range of compositions for deployment in many configurations and systems (e.g., such that the material is capable of continuous and reversible sorption and desorption of water vapor from and to the ambient environment).

The following description of hygroscopic polymer composites is provided by way of example and in sufficient detail to enable those skilled in the art to practice the disclosure. It should be understood that other embodiments may be realized, and that logical, chemical, compositional and other changes may be made without departing from the spirit and scope of the disclosure. In some implementations, a hygroscopic polymer composite is capable of sorption at a first temperature, relative humidity and/or pressure and desorption at a second temperature, relative humidity and/or pressure. The components of the hygroscopic polymer composite can be provided as a liquid, solid, or combinations thereof.

As will be described in detail below, this disclosure describes various hygroscopic polymer composites and materials, their uses and related manufacturing methods. Hygroscopic polymer composites of the present technology can comprise an ionomeric material having a three-dimensional crosslinked polymer network that can retain a large amount of water in a highly reversible manner such that the composite layer or body retains all of the water vapor which it attracts by hygroscopic affinity into its polymer matrix without weeping or leakage of liquid water. The composites disclosed herein are unique in their ability to retain high equilibrated water contents and cycle between a wide range of equilibrated water contents or relative humidities without weeping (e.g., leakage, liquid water loss, surface water formation, beading or the like). A state of weeping can be considered a failure of a material in its ability to absorb and retain all of the water that it is capable of absorbing, for example by the process of deliquescence or swelling beyond a state where the material can maintain its mechanical integrity. As such, hygroscopic polymer composites of the present technology can be considered insoluble at high equilibrated water contents such that they can be cycled across a wide range of ambient relative humidities.

Hygroscopic polymer composites disclosed herein can include a matrix of an ionomeric material and a water vapor permeable polymer material that can act as a support polymer material that imparts flexibility or rigid support for volume changes (e.g., swelling) of the ionomeric material (which can have a hygroscopic salt incorporated therein) between lower water content, drier or contracted states and higher water content or swelled states. In some cases, the water vapor permeable support polymer material can be referred to as a support polymer material. A water vapor permeable polymer material can have a porous matrix facilitating water vapor permeation and providing a rigid framework to support the volume change of the ionomeric material between the contracted state and the swelled state. Alternatively or in addition, a water vapor permeable polymer material can exhibit elasticity due to a flexible cross-linked molecular structure that its polymer chains to stretch in a swelled state and return to its original configuration in a contracted state (e.g., demonstrating viscoelastic behavior characteristic of an elastomer) to both facilitate water vapor permeation and provide a framework to support the volume change of the ionomeric material (and hygroscopic salt if incorporated therein) between high and low water contents of the composite.

In various implementations, the ionomeric material can be supported by or incorporated into (e.g., captively confined, retained, contained and/or anchored) a water vapor permeable polymer matrix or a support polymer matrix. The composite chemistry, polymeric architecture and/or pore structure can be designed such that the materials disclosed herein are uniquely capable of water vapor sorption from air and storage of moisture without weeping.

In some implementations, hygroscopic polymer composites of the present technology can further comprise a hygroscopic material, such as a hygroscopic or deliquescent salt. The hygroscopic or deliquescent salt can be incorporated (e.g., captively confined, retained, contained and/or anchored) into or by a polymeric matrix of the ionomeric material and/or the water vapor permeable polymer material that can often comprise a plurality of pores or voids. The components of hygroscopic polymer composites of the present technology can include readily available and low-cost materials that have minimal environmental impact.

The term “ionomeric material” is a term used herein to describe a polymeric material having repeat units of both electrically neutral repeating units and ionized units. Ionized units comprising fixed positive or negative charges can be positioned in the polymer backbone, as pendant group moieties, as crosslinker units, or a combination thereof. The degree of ionization or substitution of ionized units can be selected or tuned based on the desired properties and/or application and can generally range from 10-100 mol %. Furthermore, the degree of crosslinking of the ionomeric material can be selected or tuned based on the desired properties and/or application and can generally range from 1-10 mol % and/or 1-5 mol %.

In some implementations, the ionomeric material can have hygroscopic properties itself. The ionomeric material can also be referred to as an “absorbent polymer”, “absorbent material”, “water-absorbing polymer material” and/or the like as the material can absorb water vapor from air and hold the absorbed water vapor in its charged polymer network, for example via swelling or increasing in volume. Furthermore, the ionomeric material can also be referred to as a hydrogel that includes a polymer network having hygroscopic properties to attract and absorb moisture from the air.

Conventional hydrogels are limited in their ability to retain high water contents in a swelled state without weeping or loss of mechanical stability. While conventional hydrogels with higher crosslinking density can have a more rigid and compact structure, they are limited in their water sorption or uptake capacity. Furthermore, conventional hydrogels with high porosity can exhibit a greater water sorption or uptake capacity, but they have a greater tendency to weep and/or lose mechanical stability. The ionomeric materials and their composites, often including hygroscopic or deliquescent salts incorporated therein, disclosed herein offer both the ability to retain high water contents in a swelled state without weeping or loss of mechanical stability.

Composites of the present technology exhibit a unique ability to avoid weeping at wide ranges in ambient relative humidities (e.g., at relative humidity up to 60% RH, 80% RH and/or 90% RH). In various examples, the ability to avoid weeping can be due to the absorbency of a polymer gel material including an ionomeric material. The ionomeric material can be selected or designed to have a degree of crosslinking between 1-10 mol % and/or 1-5 mol % such that there are sufficient crosslinking points to form a gel, and so few that there are no mechanical restrictions to the absorbance of the gel (i.e., moisture absorbance from the air). Furthermore, composites of the present technology can comprise a water vapor permeable or “support” polymer material that is selected or designed with mechanical properties to allow for reversible expansion upon water vapor sorption/desorption cycling. In one example, the water vapor permeable polymer material can have rigid or semi-rigid pores or voids sized for the expansion of the hygroscopic component (i.e., ionomeric material and a deliquescent salt, if present) to avoid weeping. In another example, the water vapor permeable polymer material is an elastomer having flexibility to allow for reversible expansion upon water uptake, thereby avoiding a mechanical restriction that could cause weeping.

The ionomeric material in its polymerized form, and/or a monomer of the ionomeric material, can comprise a hydrophilic functional group. For example, hydrophilic moieties such as hydroxyl or alcohol groups, carbonyl groups (e.g., aldehydes, ketones), carboxyl groups (e.g., carboxylic acids), amino groups, amide groups, sulfhydryl groups thiol groups, phosphate groups, and/or a combination thereof can be used. Furthermore, the ionomeric material can comprise hydrophilic linkages such as ether linkages, ester linkages, phosphodiester linkages, glycosidic linkages (e.g., disaccharides, polysaccharides), peptide linkages and/or the like.

The term “water vapor permeable polymer”, “water vapor permeable polymer material” or “water vapor permeable material” is used herein to describe a material having a chemistry, structure and/or pore distribution to allow water vapor permeation through its structure with minimal to no liquid water penetration. The permeability can be facilitated by the chemical structure of the polymer material, for example hydrophilic functional groups such as hydroxyl (—OH), carboxyl (—COOH), and amino (—NH2) groups that can attract and hold water molecules, facilitating their passage through the polymer matrix. In various examples, the permeability of the water vapor permeable polymer can be greater than 10,000 Barrer, greater than 50,000 Barrer, greater than 100,000 Barrer, between 100,000 to 250,000 Barrer and/or between 100,000 to 250,000 Barrer. Non-limiting examples of water vapor permeable polymers include polydimethylsiloxane (PDMS), sulfonated polyetheretherketone (SPEEK), sulfonated polyethersulofone (SPES), polyether block amides (PEBA) such as PEBAX®, polybutylene terephthalate poly(ethylene oxide) (PBT-PEO) block copolymers such as 1000_{PEO}40_{PBT}60, polysaccharides such as ethyl cellulose (EC), and/or the like.

Water vapor permeable functionality can be provided via its porous structure, which can be either intrinsic or induced. Intrinsic porosity can be due to a natural occurrence of microvoids and channels within the polymer structure, whereas induced porosity can be achieved through various techniques such as phase separation, leaching, or the incorporation of porogens that are later removed. The size and distribution of pores can be designed to tune the water vapor permeable polymer, and in turn the composites' permeability to water vapor. For example, porosity of the water vapor permeable polymer and/or composite can range from 50 micron (μm) to 3 millimeter (mm) depending on the desired composition and pore structure. In various embodiments, a hierarchical pore structure can be provided depending on the desired composition and/or mechanical strength for a particular application.

In various implementations, the water vapor permeable polymer provides a framework (e.g., rigid, semi-rigid, elastic, semi-elastic) to support a volume change of the ionomeric material (and deliquescent salt incorporated therein, if present) between a contracted state (i.e., low water content, lower relative humidity) and a swelled state (i.e., higher water content, higher relative humidity) in addition to its water vapor permeability. As another example, water vapor permeability can be provided via incorporation of hydrophilic segments and/or the creation of amorphous regions within the polymer matrix. For example, polyether block amides (PEBA) such as PEBAX® having alternating polyamide and polyether blocks can effectively leverage the hydrophilic nature of polyether segments and microphase separation to facilitate water vapor transmission. Similarly, polyethylene glycol (PEG)-based polymers can leverage the hydrophilic and flexible properties of PEG chains to enhance water vapor permeability.

The term “support polymer”, “water vapor permeable support polymer”, “water vapor permeable support polymer material” or “support polymer material” is used herein to describe a polymeric material having a chemistry, structure and/or pore distribution to support the ionomeric material and in some embodiments, a hygroscopic material such as a hygroscopic salt, such that as the ionomeric material and/or hygroscopic material gains water, the resulting forces generated by the expansion or swelling due to the absorbed water are substantially contained within the support polymer matrix which provides structural support and/or mechanical strength to provide a free-standing or self-standing composite at a range of water contents and/or ambient relative humidities.

In compositions that include a hygroscopic salt, the ionomeric material can incorporate, retain and/or encapsulate the hygroscopic salt in its charged polymer network and the water vapor permeable polymer or support polymer can incorporate, retain and/or encapsulate the salt-entrained ionomeric material within its pore structure to facilitate stable sorption and desorption of water vapor so as to reduce or avoid weeping, leakage, swelling or an unstable state wherein moisture builds up on the surface of the hygroscopic polymer composite in the form of droplets and/or there is a loss of mechanical stability. In various systems and applications relevant to this technology, moisture beading on a material surface can reduce performance, result in instability and/or failure of the sorbent material (and in turn, the application or device in which it is deployed). In one failure mode, the hygroscopic material (e.g., hygroscopic salt) can migrate or separate from its supporting material resulting in an irrecoverable loss. In the composites of the present technology the ionomeric material can absorb and retain the hygroscopic material (e.g., a deliquescent salt) within its ionomeric matrix, thereby making loss of the hygroscopic material recoverable.

In some embodiments, the composite can include a filler material to provide additional water uptake capacity and/or mechanical strength such as a fibrous material, a clay material, a molecular sieve, a silicate, a polysaccharide, or a combination thereof. Additional examples include cellulose, activated carbon, perlite, vermiculite, attapulgite clay, bentonite clay, montmorillonite clay, a chitosan material, or a combination thereof.

The ionomeric material and/or water vapor permeable polymer material can be selected for high mass transport rates and high sorption kinetic rates of water vapor within the composite. Furthermore, the ionomeric material and/or water vapor permeable polymer material can be selected to minimize the weight and/or density of the hygroscopic polymer composite while maintaining reversible sorption rates over the useful lifetime of the hygroscopic polymer composite. In one example,, the water vapor permeable polymer material is a polymeric foam configured to form around the hygroscopic salt-incorporated ionomeric material in a first state (e.g., a swelled state or super-swelled state) such that air-permeable pores are formed or present when the hygroscopic salt-incorporated ionomeric material is in a second state (e.g., a contracted state or a swelled state having a lower water content that the first state).

In some hygroscopic polymer composites comprising a deliquescent or hygroscopic salt (e.g., calcium chloride, lithium chloride and/or the like), the ionomeric material can incorporate or confine the salt within its crosslinked network of ionized units when in the presence of water. A water vapor permeable polymer material can act as a support polymer material that provides a porous matrix for structural support and/or mechanical strength to support the ionomeric material incorporating the hygroscopic salt. The polymeric network of the composite can be tuned such that the technology disclosed herein provides a support platform to maintain water in the composite without weeping or leakage across a range of ambient conditions (e.g., fluctuations in relative humidity 0-99% RH, 0-90% RH, 0-80% RH and/or 0-60% RH). As a non-limiting illustrative example, the composition can be tuned for a desired humidity range such as 10-25 wt. % polymer (e.g., ionomeric material) in the composite on a solids basis (with the balance being deliquescent salt) to avoid weeping at relative humidities below 80-90% RH. As another example, composite compositions having 5-10% wt. % polymer (e.g., ionomeric material) on a solids basis (with the balance being deliquescent salt) could be employed to avoid weeping at relative humidities below 50-60% RH.

Previous approaches incorporating deliquescent or hygroscopic salts into polymer materials have been deficient due to poor containment, weeping, leakage or loss of the salt solution and thus have limited feasibility and/or performance for various applications such as water production systems and devices. Hygroscopic polymer composites of the present technology have exhibited no or low weeping, leakage or loss of water or salt solution even at high humidities, for example after exposure up to 60% RH, 80% RH and/or 90% RH (depending on a tuned composition) for at least 24 hours, 48 hours and/or 72 hours, while maintaining mechanical integrity or self-standing capability (e.g., no or minimal swelling exhibited by the composite). Furthermore, hygroscopic polymer composites of the present technology can resist anti-solvation or “salting” out of hygroscopic or deliquescent salt solutions.

Composites of the present technology can comprise a miscible gel formed by the mixture of an ionomeric material and a deliquescent salt. The deliquescent salt can be supplied to the ionomeric material as an aqueous solution and the miscibility of the ionomeric material and the deliquescent salt solution can spontaneously generate a homogenous gel mixture responsive to changes in ambient relative humidity. The mixture can remain homogenous (in particular to avoid weeping) as long as the desiccant liquid volume does not exceed the maximum absorptive capacity of the polymer or ionomeric gel. Composites in the range of 10-20 wt. % polymer can be stable in wide ranges of 0-90% RH. Furthermore, composites in the range of 5-10 wt. % polymer (i.e., ionomeric material and/or water vapor permeable polymer on a solids basis with the balance being deliquescent salt) can be stable in the relative humidity ranges of 0-60% RH.

Hygroscopic or deliquescent salts can form a stable aqueous solution equilibrated to atmospheric relative humidity. Polymers, including polymers with ionic moieties (i.e., ionomeric material), can be removed from an aqueous solution by the addition of a more water soluble compound which is a process termed as “salting out” wherein an insoluble solid precipitate or a second liquid solution of a higher concentration without miscibility with the resulting salt solution is formed. In composites of the present technology, a gel can be preferably formed by the homogeneous dispersal of the polymeric material(s) into a compatible solvent. In order to form a gel of the deliquescent salt solution, the gelling polymer needs to be soluble in the deliquescent salt solution. Furthermore, to preserve the hygroscopic functionality of both the salt and the soluble polymer gelling agent (i.e., ionomer), neither component should be consumed by the process of mixing (e.g., via metathesis, for example as occurs in mixing of calcium chloride and sodium alginate forming sodium chloride at the loss of the original ion pairs). As such, the ionomeric material, the hygroscopic salt, and the water vapor permeable or support polymer material should be selected for chemical stability therebetween. For example, mixing of the three components should not produce a metathesis reaction that could consume the components.

The term “hygroscopic media” or “hygroscopic material” is used herein to describe a functional material involved in sorption and desorption of water vapor. The term “sorption,” as used herein, refers to absorption, adsorption or a combination thereof. In various implementations, the ionomeric material can be referred to as a hygroscopic material in that it is capable of sorption and desorption of water vapor due to the chemistry and/or structure of its polymeric network. Additionally, the term “hygroscopic material” can refer to a hygroscopic or deliquescent salt that may be present in some compositions of the present technology as the salt is capable of absorbing moisture from the air and then dissolving in the water absorbed to form a solution. Furthermore, the term “hygroscopic material” can refer to a hygroscopic salt incorporated into a polymeric matrix of an ionomeric material.

Various hygroscopic materials including deliquescent salts can be included in the hygroscopic polymer composites of the present technology. For example, lithium salts, calcium salts, potassium salts, sodium salts, magnesium salts, phosphoric salts, organic salts, metal salts, ionic liquids, glycerin, glycols, or combination thereof. Non-limiting examples of deliquescent or hygroscopic salts include calcium chloride, calcium bromide, magnesium chloride, magnesium sulfate, ammonium chloride, lithium bromide, lithium chloride, zinc bromide, sodium bromide, sodium chloride, sodium carbonate, lithium iodide, sodium iodide, sodium sulfate, potassium iodide, potassium carbonate, potassium iodide, potassium sulfate, potassium acetate, potassium bromide, zinc sulfate, combinations thereof and/or derivatives thereof.

In some implementations, a hygroscopic polymer composite can comprise a first hygroscopic or hydrophilic component, such as a deliquescent salt, incorporated into or within a second hygroscopic or hydrophilic component that is an ionomeric material, such as a cationic or anionic polymer. The ionomeric material can have repeat units of both electrically neutral units and ionized units, wherein the ionized units can be covalently bonded to the polymer backbone as pendant group moieties and/or ionized moieties in the polymer backbone itself. The ionomeric material chemistry (e.g., ionized units) can captively confine, entrain or retain the hygroscopic salt in the ionomeric matrix. In such implementations, the hygroscopic salt can be present in the amount of 1 to 80 weight (wt.) % of the ionomeric material, 5 to 60 wt. % of the ionomeric material and/or greater than 20 wt. % of the ionomeric material.

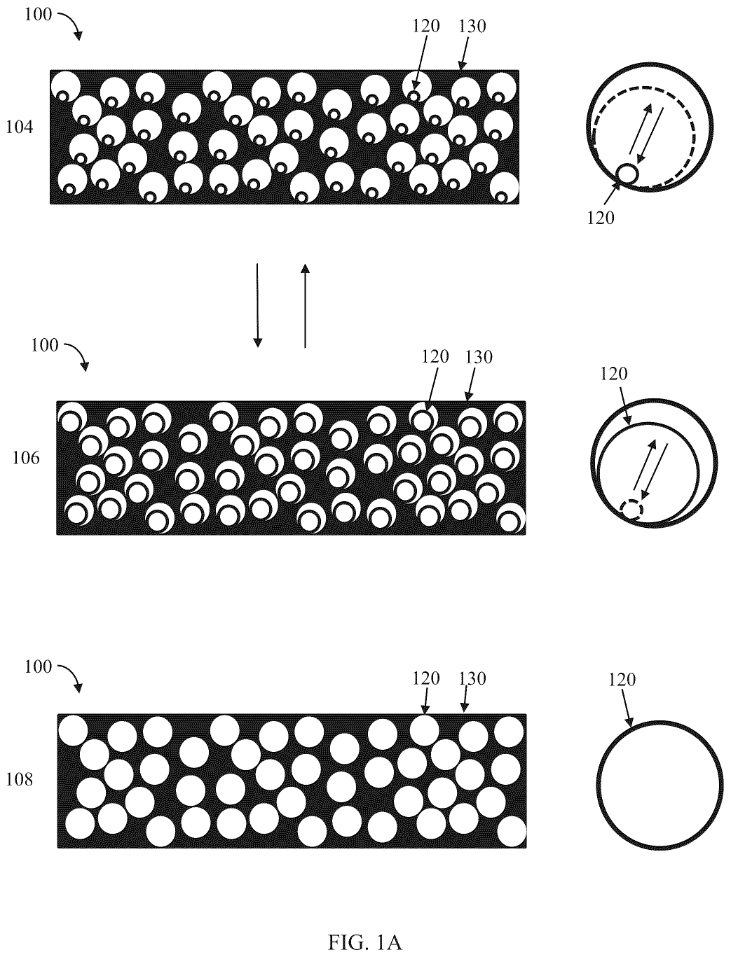

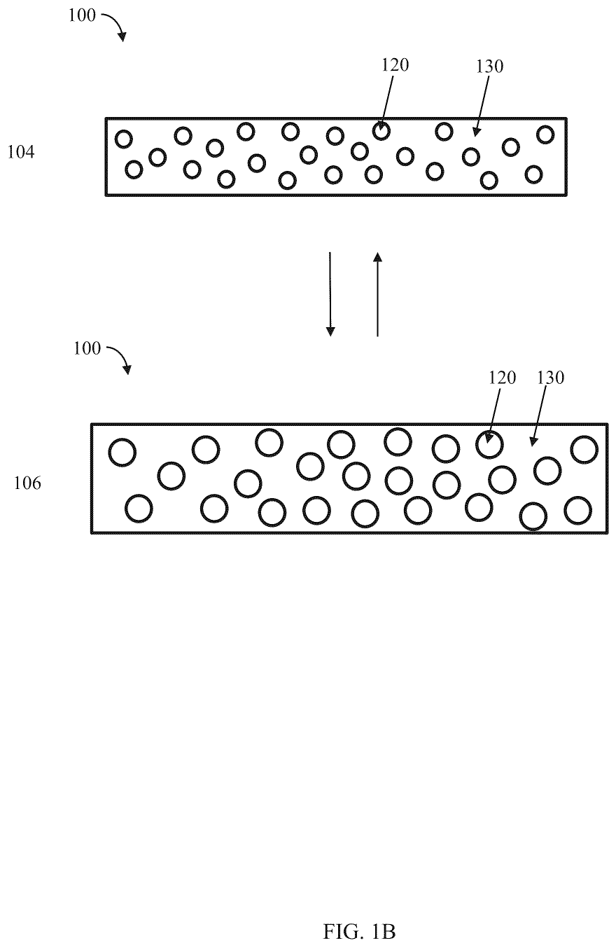

FIG. 1A depicts a schematic illustration of hygroscopic polymer composite 100 comprising an ionomeric material 120 retained within a plurality of pores or voids of a water vapor permeable polymer material 130. In some implementations, an ionomeric material 120 and a hygroscopic salt can be provided within water vapor permeable polymer material 130. In a drier or contracted state 104, the ionomeric material 120 has a low or reduced content of water and increases in volume, or swells, to a swelled state 106 with a higher water content, for example as a result of an increase in relative humidity and/or reduction in temperature. Similarly, the ionomeric material 120 can decrease in volume, or contract, from a swelled state 106 to a contracted state 104, for example as a result of a decrease in relative humidity and/or increase in temperature. As the ionomeric material expands and contracts during water vapor sorption/desorption (i.e., water uptake and release), the water vapor permeable polymer 130 functions as a support polymer 130 by facilitating reversible water sorption cycling so as to maintain mechanical stability of the composite (e.g., without swelling of the composite itself) and without weeping, leakage or formation of liquid water across a range of ambient conditions (e.g., fluctuations in relative humidity 0-99% RH, 0-90% RH). As such, the composite 100 itself remains mechanically stable as the ionomeric material swells or expands with increasing water content.

In a super-swelled state 108, the ionomeric material 120 can swell or expand to fill the pores or voids of water vapor permeable support polymer material 130. A super-swelled state can be referred to as a state having such a high water content that water saturates the ionomeric polymer beyond the maximum equilibria water uptake under an atmospheric condition. In a super-swelled state 108, the composite can lose open pore volume to allow for airflow through the hygroscopic polymer composite and/or lose mechanical integrity. As such, the composite 100 can be chemically, compositionally and structurally designed such that operation of a device or system incorporating composite 100 can reversibly operate between the swelled state 106 and contracted state 104 such that volume changes of ionomeric material 120 are supported by the mechanical integrity of the water vapor permeable support polymer network 130 to allow airflow for reversible water sorption/desorption without weeping, leakage or loss of liquid water across a range of ambient conditions (e.g., fluctuations in relative humidity 0-99% RH, 0-90% RH). As such, the composite 100 transitions between contracted state 104 and swelled state 106 during normal operation of a system or device incorporating the composite 100. A degradation or failure mode can exist if the composite enters super-swelled state 108 during operation of a system or device incorporating the composite 100.

However, it may be desirable at times to push the ionomeric material into a super swelled state (e.g., state 108). For example, a manufacturing process can include driving the ionomeric material into a super-swelled state to form pores or voids within the water vapor permeable support polymer matrix or foam. These pores or voids will become accessible pores or voids for airflow through the composite upon use of the composite in a system or device. Upon drying of the ionomeric material 120 from the super-swelled state 108 to an equilibrated swelled state 106 or a drier (and also equilibrated) contracted state 104, air-permeable pores within the water vapor permeable support polymer are established for the operational life of the composite.

FIG. 1B depicts another illustration of hygroscopic polymer composite 100 comprising an ionomeric material 120 within water vapor permeable polymer material 130. In some implementations, an ionomeric material 120 and a hygroscopic salt can be provided within water vapor permeable polymer material 130. In a drier or contracted state 104, the ionomeric material 120 has a low or reduced content of water and increases in volume, or swells, to a swelled state 106 with a higher water content, for example as a result of an increase in relative humidity and/or reduction in temperature. Similarly, the ionomeric material 120 can decrease in volume, or contract, from a swelled state 106 to a contracted state 104, for example as a result of a decrease in relative humidity and/or increase in temperature. As the ionomeric material expands and contracts during water vapor sorption/desorption (i.e., water uptake and release), the water vapor permeable polymer 130 can also expand and contract such that it provides elastic support and thus, facilitate reversible water sorption cycling without weeping, leakage or formation of liquid water across a range of ambient conditions (e.g., fluctuations in relative humidity 0-99% RH, 0-90% RH). As such, the composite 100 itself remains mechanically stable as the ionomeric material swells or expands with increasing water content.

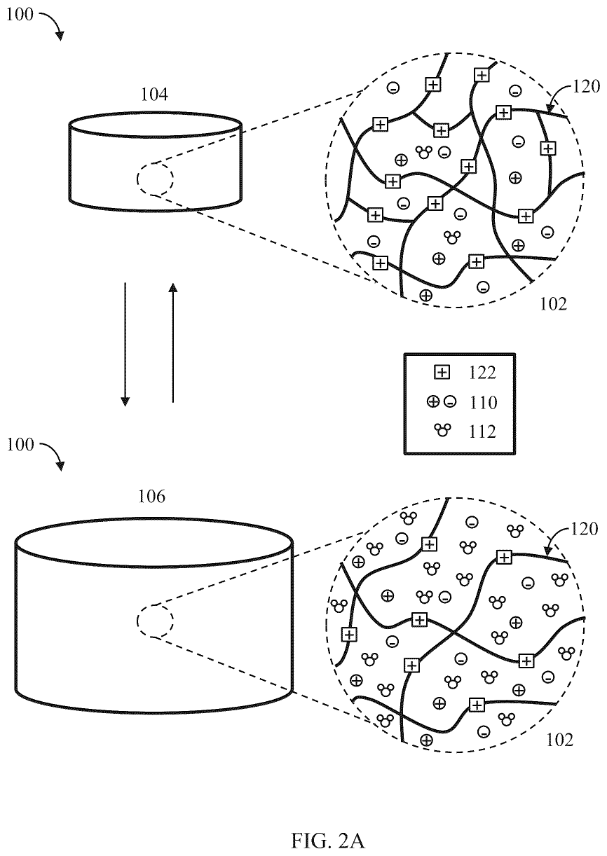

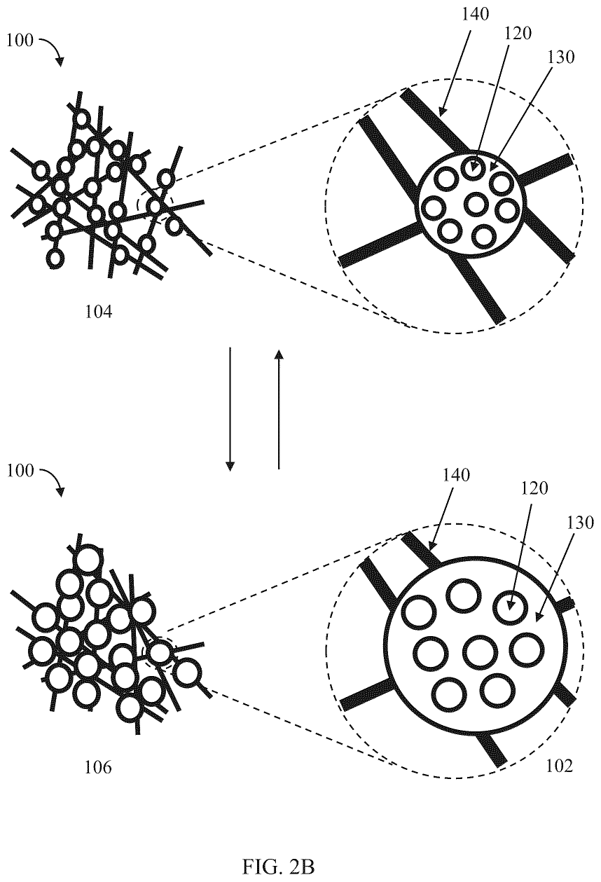

FIG. 2A depicts another illustration of a hygroscopic polymer composite 100 comprising a hygroscopic salt 110 including a mobile cation (e.g., Li⁺, Ca²⁺) and a mobile anion (e.g., Cl⁻, Br⁻) incorporated into a polymeric matrix of an ionomeric material 120. As an illustrative example, the ionomeric material 120 is depicted as a cationic polymer comprising fixed cationic units 122 of the polymeric chains including crosslinks. Alternatively, an anionic polymer could be employed without departing from the spirit and scope of the disclosure. FIG. 2 depicts when the hygroscopic salt-incorporated ionomeric material 102 in a first state (e.g., contracted state 104) having a low content of water molecules 112 with a reversible a transition or expansion to a second state (e.g., swelled state 106) having a higher content of water molecules 112.

FIG. 2B depicts yet another illustration of a hygroscopic polymer composite 100 comprising an ionomeric material 120 within water vapor permeable polymer material 130 dispersed or support in a reinforcing fiber material 140 (e.g., carbon fiber, glass fiber). In some implementations, both an ionomeric material 120 and a hygroscopic salt can be provided within water vapor permeable polymer material 130. As the ionomeric material expands and contracts between a first state (e.g., contracted state 104) and a second state (e.g., swelled state 106), the water vapor permeable polymer 130 may also expand, possibly providing at least some elastic support, while the reinforcing fiber material 140 can provide mechanical stability upon sorption cycling. Furthermore, the reinforcing fiber material 140 can facilitate dimensional stability of the composite at the macroscopic scale (e.g., as an absorber body, tile or other formed component).

The ionomeric material and/or a hygroscopic salt (if present) can be provided in the composite at a threshold determined by weeping, swelling or other stability characteristics of the particular material. A weeping, swelling or instability condition or state can occur when a hygroscopic material absorbs a high enough amount of water to begin forming an aqueous solution that can irreversibly migrate from the hygroscopic polymer composite. Swelling and weeping instability of the ionomeric material at higher water contents can be mediated or eliminated by the ionomeric polymer, water vapor permeable polymer and/or support polymer framework such that mechanical stability and accessibility of pores or voids of the composite is maintained in the absence of weeping. For example, the solubility of the ionomeric polymer and/or water vapor permeable polymer in a deliquescent salt of the composition can be such that a weeping state does not occur even at high relative humidities. As such, a pressure drop for airflow through the composite can be minimized and/or degradation or failure of the system in which the composite material is deployed can be avoided.

A greater content of the ionomeric material and/or a hygroscopic salt (if present) in the composite can support sorption of a greater amount of water, however it can also drive a weeping, swelling or instability condition at a lower total water content of the composite. In one example, at a lower ratio of absorbed water to hygroscopic material, the hygroscopic polymer composite can bind water more strongly and as such, more energy can be required to desorb the ‘lower-grade’ or more strongly bound water upon desorption. In other words, the water vapor pressure of the hygroscopic polymer composite at a higher water content (e.g. at a high relative humidity and/or low ambient temperature) may require less energy to desorb (i.e. has a lower binding energy), whereas the water vapor pressure of the hygroscopic polymer composite at a lower water content (e.g. at a low relative humidity and/or high ambient temperature) may require more energy to desorb (i.e. has a higher binding energy).

Various illustrative examples of ionomeric materials that can be used in hygroscopic polymer composites are provided herein. In a preferred embodiment, the ionomeric material is provided as a cationic polymer with monovalent anions such as halide anions (e.g., chloride, bromide) to drive hygroscopic properties. However, anionic polymer materials can be used as an ionomeric material of a hygroscopic polymer composite, for example calcium alginate or sodium alginate ionically crosslinked by polyvalent cations, although other monovalent cations, including ionic liquid cations can reduce hygroscopic properties relative to monovalent anions (e.g., chloride anions of a cationic polymer material).

Two exemplary cationic polymer materials based on a poly diallyldimethylammonium chloride (poly-DADMAC) and a modified chitosan are provided herein to illustrate the opportunity presented by composites incorporating them, as well as their tunability or possible variations, analogs and derivatives (e.g., via hydrophilic functionalization, crosslinked structures, and/or the like). However, many other cationic or anionic polymer materials can be used as an ionomeric material of a hygroscopic polymer composite and logical, chemical, compositional and other changes may be made without departing from the spirit and scope of the disclosure. For example, ionomeric materials based on polyamides, polyacrylamides, polysaccharides, polycarbonates, polyisocyanates, polyepoxides, polyurethanes, peptides, alginates and/or derivatives and combinations thereof could be used as an ionomeric material in a hygroscopic polymer composite. Furthermore, various cationic or anionic polymers can be functionalized to increase hygroscopicity, for example via quaternized ammonium and/or hydroxy groups.

The exemplary polydiallyldimethylammonium chloride (poly-DADMAC) ionomeric material comprises repeating units of diallyldimethylammonium chloride (DADMAC) monomers linked together via carbon bonds to form a polymer chain. The structure of poly-DADMAC can vary depending on the degree of polymerization, the degree of crosslinking, the polymerization process as well as crosslinker and functionalization agents used and provides a platform to illustrate ionomeric material functionalization for use in hygroscopic polymer composites of the present technology.

In one example, the hygroscopic properties of the ionomeric material can be tuned by modifying the degree of crosslinking (i.e., the extent of chemical bonds formed between polymer chains forming a three-dimensional polymeric network quantified as percentage of crosslinked bonds relative to total number of available bonding sites). The ionomeric material (e.g., poly-DADMAC) can be crosslinked below 3 mol %, below 5 mol % and/or at or below 10 mol % to set water sorption capacity high enough to be used as an ionomeric material in composites of the present technology. An increased degree of crosslinking (e.g., greater than 10%, greater or equal to 20%) can reduce swelling but also reduces water sorption capacity. Because the porous matrix of the water vapor permeable support polymer material supports volume changes of the ionomeric material during sorption cycling, it can be preferable to maintain the degree of crosslinking of the ionomeric material equal to or below 10% to maintain hygroscopicity. However, there can be some implementations where the chemistry of the ionomeric material and the support material are similar but have modifications or variations such that the ionomeric material has a high hygroscopicity and the support material has a high mechanical strength. As an illustrative example, a composite could comprise an ionomeric material including poly-DADMAC having 5% crosslinking and include a poly-DACMAC support material having 20% crosslinking.

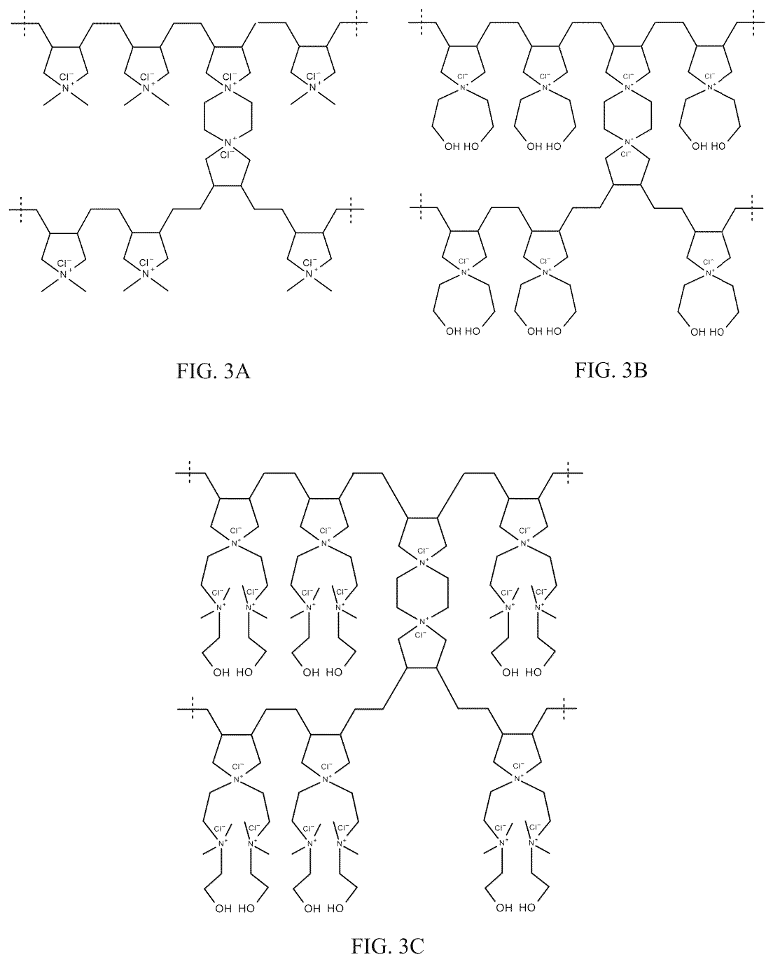

FIG. 3A depicts an exemplary chemical structure of a poly-DADMAC including a piperazinium crosslinker for use as an ionomeric material in a hygroscopic polymer composite. Various modifications or functionalization of poly-DADMAC are possible, for example to increase the hydrophilic properties of the ionomeric material. As an illustrative example, FIG. 3B depicts a hydroxy-functionalized poly-DADMAC ionomeric material, specifically dihydroxymethyl functionalized poly-DADMAC including a piperazinium crosslinker. Poly-DADMAC having hydroxy moiety functionalization can increase the hydrophilicity of poly-DADMAC. However, other functional groups can be used including amines and quaternized ammoniums to increase hygroscopic functionality.

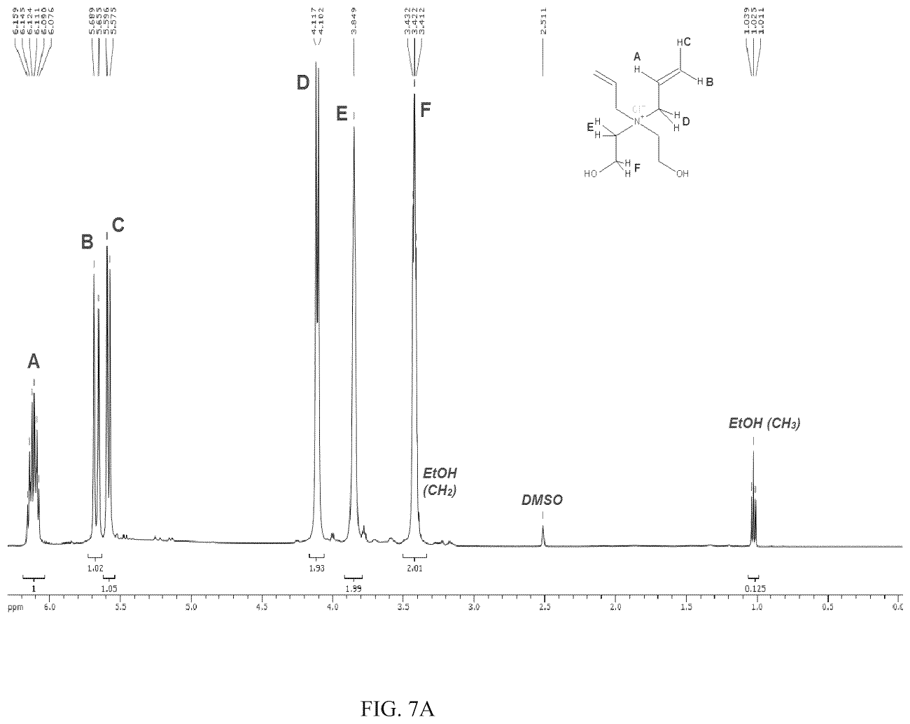

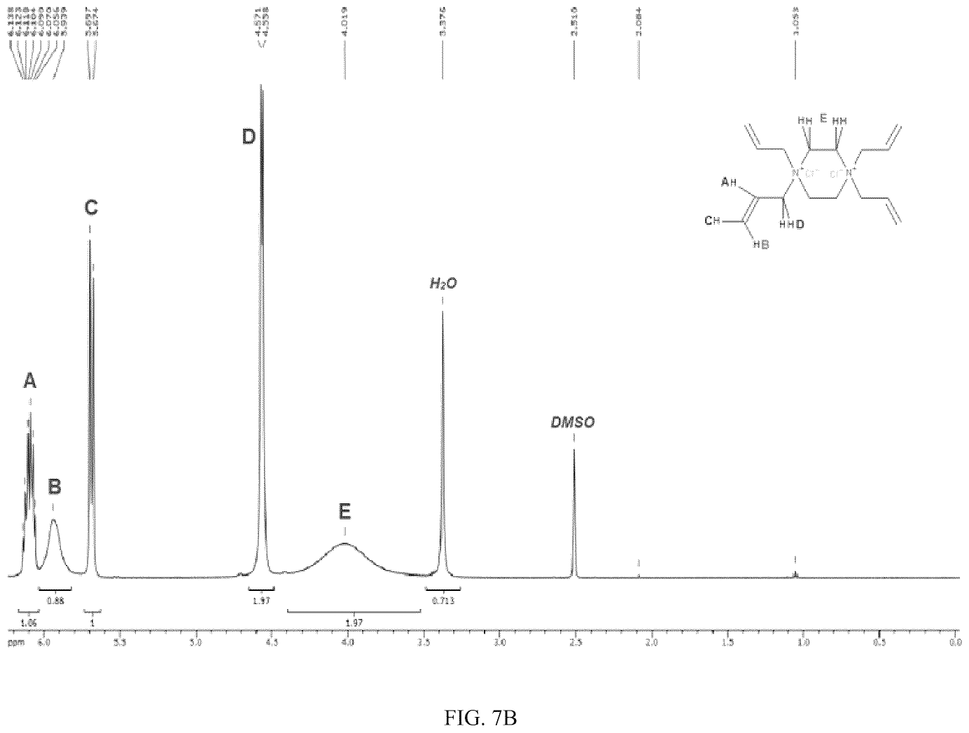

A hydroxymethyl-functionalized poly-DADMAC can be synthesized via polymerization of a hydroxymethyl DADMAC monomer. FIG. 7A is a typical NMR spectra of a hydroxymethyl DADMAC monomer, specifically diallyldiethanolammonium chloride. Diallyldiethanolammonium chloride can be synthesized by reacting diethanolamine with allyl chloride in warm ethanol in the presence of sodium bicarbonate for an extended period of time (e.g., greater than 65 hours) resulting in a yield close to quantitative, i.e., 100%.

As another illustrative example, FIG. 3C depicts a hydroxy-functionalized poly-DADMAC ionomeric material including additional quaternary ammonium functionalization, specifically the chemical structure of a 2-hydroxyethyl-N,N-dimethylaminiummethyl chloride functionalized polydiallyldimethylammonium chloride (poly-DADMAC). Additional quaternary ammonium groups are introduced to increase cationic charge density in addition to hydroxyl groups to increase hydrophilicity. Other types of functionalization are also possible to tune hygroscopicity of the ionomeric material depending on desired properties and application. For example, poly-DADMAC can be copolymerized with other monomers or polymers to drive hydrophilic properties and/or other desirable properties. Furthermore, poly-DADMAC can be grafted onto other polymers or surfaces depending on the particular application.

FIG. 3C shows one example of a hydroxy-functionalized poly-DADMAC ionomeric material including quaternary ammonium functionalization, however many other structures are also possible. For example, a poly-DADMAC ionomeric materials could have greater or more complicated branching of the polymer at the diallylammonium position, for example polyhydroxyl or polycationic branches.

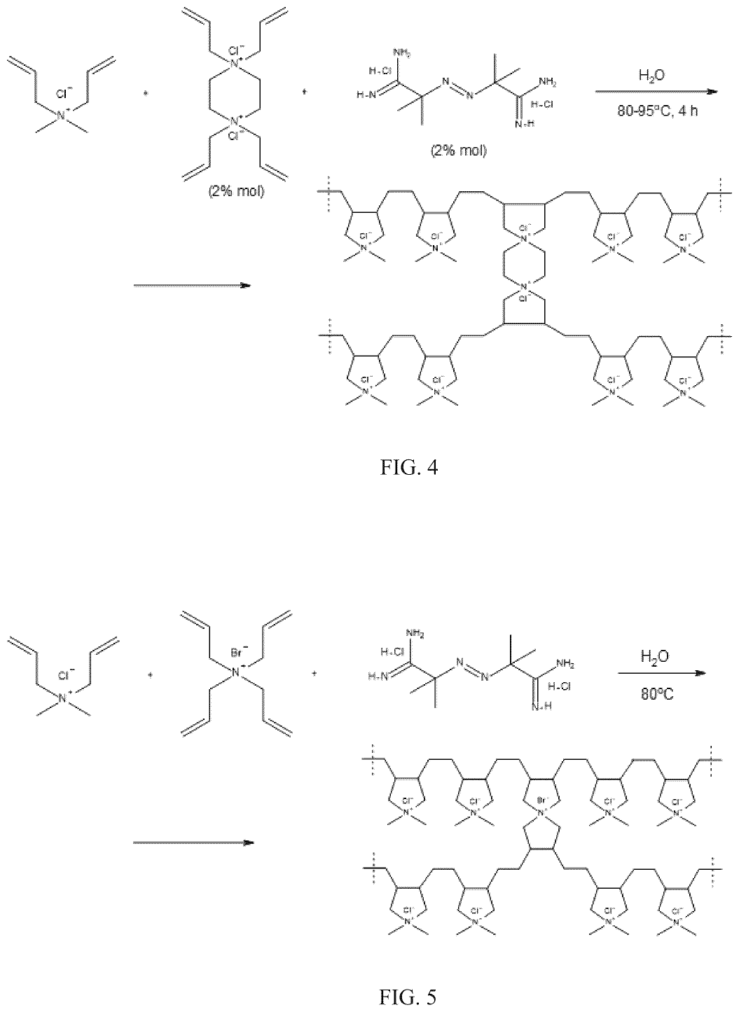

The hydroxymethyl functionalized poly-DADMAC ionomeric material of FIG. 3A can be synthesized from a diallyldimethylammonium chloride (DADMAC) monomer by various polymerization routes. In the example of FIG. 4, the poly-DADMAC ionomeric material shown in FIG. 3A is synthesized via polymerization of a DADMAC monomer and a piperazinium crosslinker such as 1,1,4,4-tetraallylpiperazinium dichloride crosslinker. The use of the tetraallyl piperazinium crosslinker can increase the interchain distance in the polymer and thus improve the hygroscopic capacity of the ionomeric material.

FIG. 7B is an example of a typical NMR spectra of 1,1,4,4-tetraallylpiperazinium dichloride crosslinker that can be synthesized in two steps. In a first step, a monoquaternized intermediate 1,1,3-triallylpiperazinium chloride can be prepared by reacting piperazine with allyl chloride in warm ethanol in the presence of sodium bicarbonate for an extended period of time (e.g., greater than 40 hours). In a second step, the obtained triallyl monoquaternized intermediate can undergo a second quaternization with allyl chloride under heating in a pressurized vessel for an extended period of time (e.g., greater than 72 hours) resulting in a summary yield for a two-step synthesis greater than 70%.

Various crosslinking agents can be used depending on the desired properties and applications of the ionomeric material of the composite. While various allyl or divinyl crosslinkers can produce more rigid and stable polymer structures, interchain distance in the polymer can change the hygroscopic capacity of the ionomeric material. In the illustrative example of FIG. 5, another poly-DADMAC ionomeric material is synthesized via polymerization of a DADMAC monomer, a tetraallylammonium crosslinker and a 2,2′-azobis(2-methylpropionamidine) dihydrochloride radical initiator which can reduce the interchain distance and thereby reduce the hygroscopic capacity of the ionomeric material.

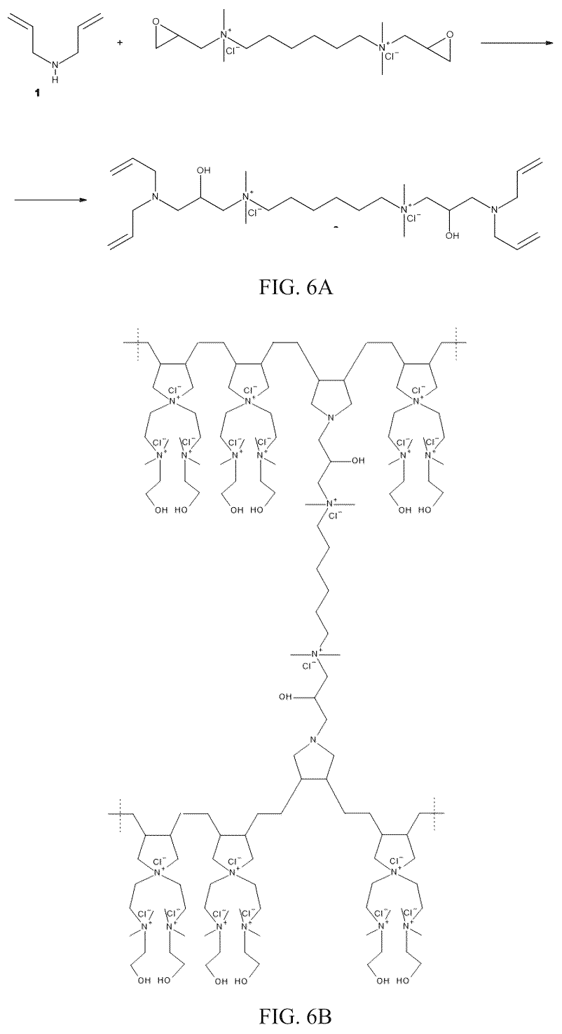

As another illustrative example, FIG. 6A depicts synthesis of a long chain tetraallyl-substituted diaminium crosslinker from diallylamine and N,N′-bis(oxiranylmethyl)-N,N,N′,N′-tetramethyl-1,6-hexanediaminium dichloride which can be used in a polymerization reaction to form a hydroxy aminium functionalized poly-DADMAC ionomeric material, specifically 2-hydroxyethyl-N,N-dimethylaminiummethyl functionalized poly-DADAMAC including a long chain tetraallyl-substituted crosslinker shown in FIG. 6B. The modified poly-DADMAC polymer chain is functionalized to include additional quaternary ammonium groups increasing cationic charge density and hydroxyl groups increasing hydrophilicity. Furthermore, the long chain crosslinker increases interchain distance (e.g., form “cages” between poly-DADMAC polymer chains accommodating more water molecules) to further increase hygroscopic capacity of the ionomeric material.

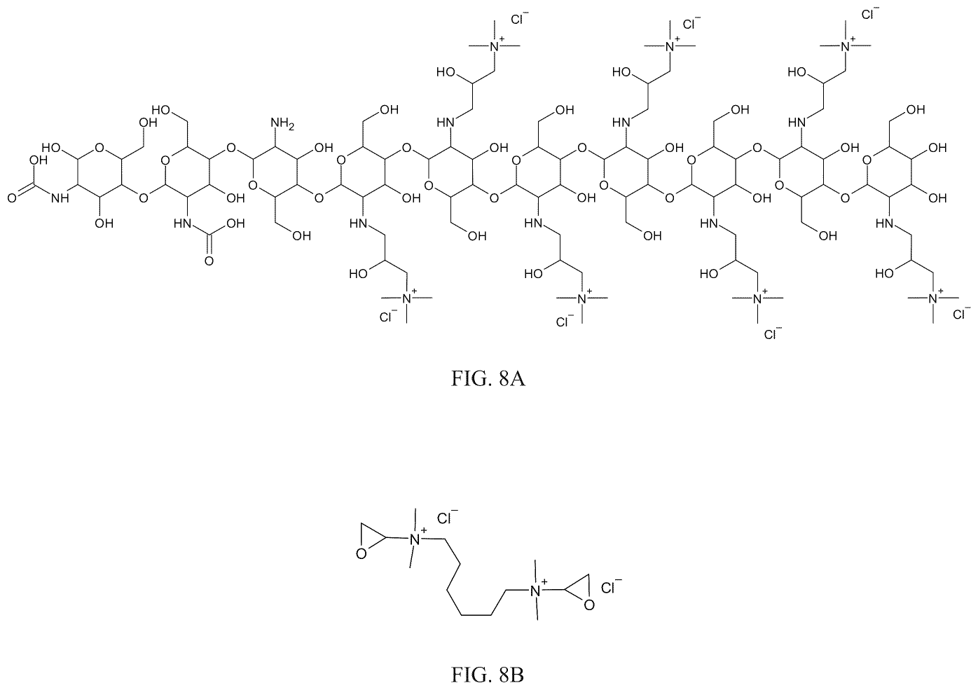

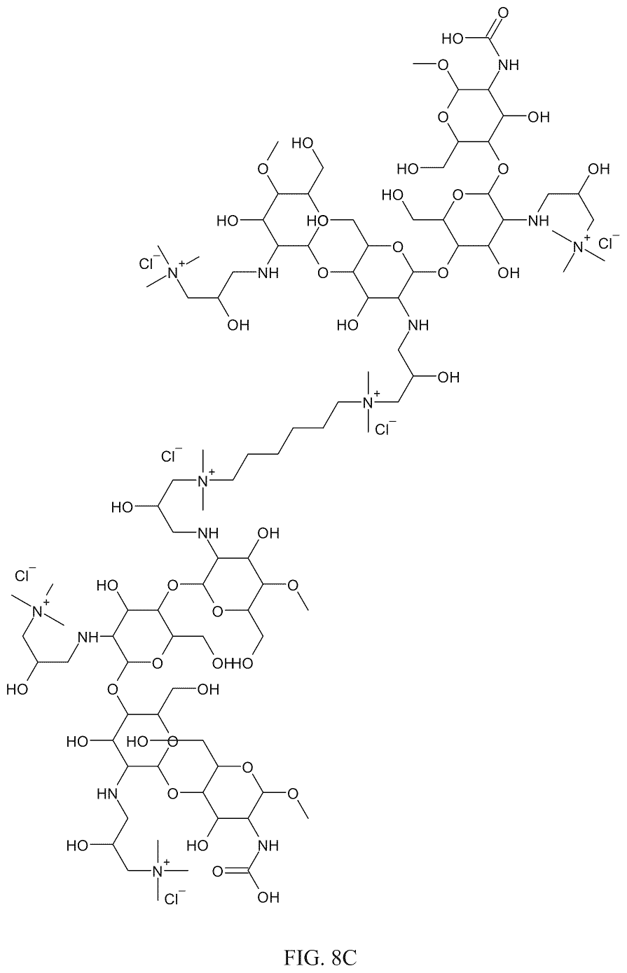

A cationic polymer material based on a modified polysaccharide, specifically chitosan, is now provided as another exemplary ionomeric material that can be used in hygroscopic polymer composites of the present technology. In the example shown in FIG. 8A-C, an ammonium functionalized chitosan material shown in FIG. 8A is prepared such that permanently positively charged quaternary ammonium groups are substituted at 2-amino/2-acetamido positions in the polymer.

FIG. 8A depicts an aminium functionalized chitosan ionomeric material precursor produced via substitution with trimethylammonium glycidyl chloride. In this illustrative example, a high molecular weight chitosan is under-substituted to leave one available amino (—NH2) group every 15 monomeric units. An ionomeric material comprising a crosslinked ammonium functionalized chitosan shown in FIG. 8C can be synthesized via polymerization of the ammonium functionalized chitosan of FIG. 8A and a diaminium diepoxide crosslinker, such as N,N′-bis(oxiranylmethyl)-N,N,N′,N′-tetramethyl-1,6-hexanediaminium dichloride crosslinker shown in FIG. 8B. The diaminium diepoxide crosslinker of FIG. 8B is provided as an example, however, other linear, branched and/or heterocyclic diepoxides can be used.

In an exemplary synthetic method of diepoxide crosslinkers that can be used herein, the diaminium diepoxide crosslinker of FIG. 8B can be produced in aqueous solution from commercially available N,N,N′,N′-tetramethyl-1,6-diaminohexane. An aqueous solution of N,N,N′,N′-tetramethyl-1,6-diaminohexane can be cooled (e.g., via ice bath), and epichlorohydrin in 3-fold molar excess can be added in a dropwise manner. The formed emulsion can be stirred in a water bath for an extended period of time (e.g., over 19 hours) until the emulsion turns to a clear solution. The mixture can be extracted with ethyl acetate one or more times to remove excess epichlorohydrin to produce an aqueous solution of N,N′-bis(oxiranylmethyl)-N,N,N′,N′-tetramethyl-1,6-hexanediaminium dichloride.

In some embodiments, the composite can include a filler material such as a fibrous material, a clay material, a molecular sieve, a silicate, a polysaccharide, or a combination thereof. As an illustrative example, a hygroscopic salt and a clay filler material can be included in a composite comprising the exemplary crosslinked ammonium functionalized chitosan shown in FIG. 8C. A first synthetic step or operation can include reacting trimethylammonium glycidyl chloride and chitosan in an aqueous solution via heating (e.g., >80° C.) and stirring to form the ammonium functionalized chitosan ionomeric material precursor of FIG. 8A. The ammonium functionalized chitosan ionomeric material precursor of FIG. 8A, a hygroscopic salt (e.g., calcium chloride) and a clay material (e.g., montmorillonite clay) can be reacted in a single step in an aqueous solution via heating (e.g., >80° C.) and stirring to form a hygroscopic salt-incorporated ionomeric material including a clay material filler. The composite can then be prepared by mixing the hygroscopic salt-incorporated ionomeric material including the clay material filler with components of the water vapor permeable polymer material. For example, components of the water vapor permeable polymer can be provided as a polyisocyanurate foam by reacting a first component comprising isocyanate and a second component comprising polyol.

The composition or relative amounts of each component of the composite can be set depending on the desired hygroscopicity and application or use. Generally, the composition of the composite can comprise the water vapor permeable polymer in a range from 20 to 50% by weight (w/w) of the composite. As additional examples, the amount of ionomeric material in the composite can range from 20 to 50% by weight (e.g., poly-DADMAC, modified chitosan), 10 to 40% by weight hygroscopic salt (if present), and 20 to 50% by weight filler (if present).

Water vapor permeable or support polymer materials in hygroscopic polymer composites of the present technology can comprise a chemistry, structure and/or pore distribution to support the ionomeric material and a hygroscopic salt (if present), such that water gained by the ionomeric material and/or hygroscopic salt is contained within the support polymer matrix across a range of water contents and/or relative humidities without weeping of liquid water from the composite. In some implementations, the water vapor permeable or support polymer material is a polymeric foam configured to form around the ionomeric material and hygroscopic salt (if present).

Exemplary polymeric foam materials based on polyisocyanurate or polyurethane are provided herein, however many other support polymer materials can be used in the hygroscopic polymer composites of the present technology and logical, chemical, compositional and other changes may be made without departing from the spirit and scope of the disclosure. Various support polymer materials can be used based on polyisocyanurate, polyurethane, polyimide, phenolic resins and/or the like in hygroscopic polymer composites of the present technology.

The amount of water vapor permeable polymer material in the hygroscopic polymer composite can vary based on the particular ionomeric material(s) and/or hygroscopic salts (if present), however the compositional ranges of composites of the present technology can generally range between 15 to 70 wt. % of the water vapor permeable polymer, and/or 10 to 50 wt. % of the ionomeric polymer, and/or 5 to 40 wt. % hygroscopic salt (if present).

In some implementations, the water vapor permeable polymer material can be selected, modified or functionalized depending on the application or use of the composite. In one example, the water vapor permeable polymer material can be provided as or comprise a hydrophobic polymer and can at least partially resist water sorption so as to maintain structural integrity of the composite when exposed to moisture. Some exemplary hydrophobic polymer foams that can be included in the composite include polyurethane (PU) foam, polyisocyanurate (PIR), polyethylene (PE) foam, polypropylene (PP) foam, polystyrene (PS) foam, polyvinyl chloride (PVC) foam, their derivatives or combinations thereof.

Various methods of manufacturing the hygroscopic polymer composite can be employed. In some implementations, the ionomeric material, and in some embodiments incorporating a hygroscopic or deliquescent salt, can be produced separately and then mixed or otherwise combined with the water vapor permeable polymer material. In other implementations, precursors and/or monomers of the ionomeric material, the water vapor permeable polymer material and the hygroscopic salt (if present) can be synthesized or reacted simultaneously.

In one example, a water vapor permeable polymer foam can be formed around a portion (e.g., fragments, granules, chunks, and/or the like) of the ionomeric material (which may or may not have a hygroscopic salt incorporated therein). In such an implementation, the ionomeric material ionomeric material (which may or may not have a hygroscopic salt incorporated therein) can be provide in a super-swelled state and the water vapor permeable polymer foam can be formed around the ionomeric material in the super-swelled state. A super-swelled state can be referred to as a state having such a high water content that water saturates the ionomeric polymer (and incorporated hygroscopic salt if present) beyond the maximum equilibria water uptake under an atmospheric condition (e.g., 30% RH, 60% RH, 90% RH at 25° C.). When in a super-swelled state, the ionomeric material (and incorporated hygroscopic salt if present) can have so much water that it is swelled or expanded such that upon water loss to an equilibrated state, the composite including the support material has open pore volume to allow for airflow through the hygroscopic polymer composite. Upon drying of the ionomeric material (and incorporated hygroscopic salt if present), for example to an equilibrated swelled state or a contracted state, air-permeable pores within the water vapor permeable polymer foam of the hygroscopic polymer composite can be formed.

The ionomeric material (including an incorporated hygroscopic salt, if present) can be placed into different swell states or degrees of swelling during preparation or manufacture of the composite. The ionomeric material can reach a predetermined equilibrated swell state when exposed to air at a predetermined relative humidity (% RH) and temperature. Furthermore, during a manufacturing operation, the ionomeric material can be pushed beyond its equilibrated swell state such that the degree of swelling or volume change is greater than that reached by absorbing atmospheric water vapor, for example via contact with liquid water or aqueous solutions. In one method of preparation of the composite, an operation can include contacting an ionomeric material with a hygroscopic salt solution until a super-swelled state is reached. A predetermined super-swelled state that saturates the ionomeric material beyond the maximum equilibria water uptake under an atmospheric condition can be set to ensure enough space is provided in the composite pores to allow the airflow through the composite material.

In another exemplary method for preparation or manufacture of the composite, the ionomeric material (which may or may not have a hygroscopic salt incorporated therein) can be anchored to the water vapor permeable polymer material, for example via co-polymerization of monomers of the ionomeric material (or its polymer) and the supporting polymer material. In such an implementation, a monomer of the ionomeric material (or its polymer) can comprise a functional group reactive to the supporting polymer material. For example, the functional group of the monomer of the ionomeric material (or its polymer) can be selected from a group of nucleophilic nature, such as a primary or secondary amine, a primary or secondary alcohol, a primary or secondary thiol, or a combination thereof. As an additional example, the supporting polymer material can be selected from the group of electrophilic nature: isocyanate, epoxide, activated carboxylic group, active alkyl halides or a combination thereof. Furthermore, methods can include reacting a first monomer of the ionomeric material comprising the hygroscopic salt with a second ionomeric or non-ionomeric monomer.

The water vapor permeable polymer material or the support polymer material can be prepared by reacting a first component comprising isocyanate (e.g., methylene diphenyl diisocyanate (MDI)) and a second component comprising polyol react. In implementations where the support polymer material is a polyurethane foam, the amount of isocyanate component less than or equal to 105% of the chemical equivalent of the polyol component, whereas a polyisocyanurate support polymer material can be prepared with a greater ratio (e.g., greater than 105% of the isocyanate component relative to the polyol component). In some preparation methods, a blowing agent used during preparation can create and stabilize the porous matric of the support polymer material by generating gas bubbles. Blowing agents can be physical and/or chemical blowing agents, for example water, carbon dioxide, carbonates like sodium bicarbonate or ammonium bicarbonate, hydrogen generating metals like aluminum, azodicarbonamide (ADC), hydrochlorofluorocarbons (HCFCs) and/or hydrofluorocarbons (HFCs) can be used during production of the composite. Furthermore, various catalysts and/or surfactants can be used to form the support polymer material. Various preparation modifications such as the type of catalyst, temperature swing between a thermoactivated polymerization (e.g., >80° C.) and room temperature polymerization, can be employed depending on the desired properties and particular application.

The mixture of the isocyanate component and the polyol component can be referred to as the support material precursor mixture which can be combined with the ionomeric material in a stepwise or one step method. In a preferred synthetic method of producing the composites of the present technology, the water vapor permeable polymer synthesis (e.g., polymerization) is conducted when the ionomeric polymer (and the hygroscopic salt incorporated therein, if present) is in a super-swelled state, for example, so as to architect the porous matrix of the composite to allow for airflow and/or porous structural framework facilitating reversible sorption/desorption cycling during normal operation or use.

The hygroscopic polymer composite can be manufactured with a porous architecture that can include a hierarchical porosity, a reticulated pore network and/or the like depending on the application. In some implementations, production methods can include the use of foaming, blowing or aeration agents and/or physical molding or templating. Depending on planned use and/or ambient environment at installation location, the formulation of the hygroscopic polymer composite can be modified and can include various additives to tune porosity, mechanical strength, thermal conductivity and/or stable water vapor sorption/desorption reversibility for a particular ambient environment and/or application.

The porosity of the water vapor permeable or support polymer material can be tuned via the water content during synthesis, the amount of ionomeric material present, a reaction temperature, blowing agent(s) and/or by including surfactant(s). Pore sizes of the composite and/or the water vapor permeable or support polymer material, can range from 50 micron (μm) up to 3 millimeters (mm), depending on the application. Furthermore, the composite and/or the water vapor permeable polymer material can have a pore structure that can be hierarchically porous (e.g., microporous, mesoporous and/or microporous) with pore sizes ranging from about <2 nm (micropores) to about 50 μm (mesopores) and up to the millimeter scale (macropores).

In some embodiments, agents for controlled bubble formation, foaming and/or mixture expansion can be employed. For example, a blowing, foaming, aerating or expansion agent(s) can include one or more materials to control dispersion of components in the mixture, bubble size and/or expansion of the mixture. In an example, a surfactant (e.g., anionic surfactant, cationic surfactant non-ionic surfactant, functionalized polymers and/or the like) can act as a stabilizing agent in combination with another blowing agent. In various examples, agents for controlled bubble formation can comprise a nonionic surfactant (e.g., cocamide-, ethoxylate-, or alkoxylate, polyethylene oxide-based), an anionic surfactant, (e.g., gluconate-, sulfonate-or sulfate-based), or cationic surfactant (e.g., alkyl ammonium chloride-based). The surfactant can be provided during mixing to form a foam or be pre-foamed before mixing with the other components of the composite.

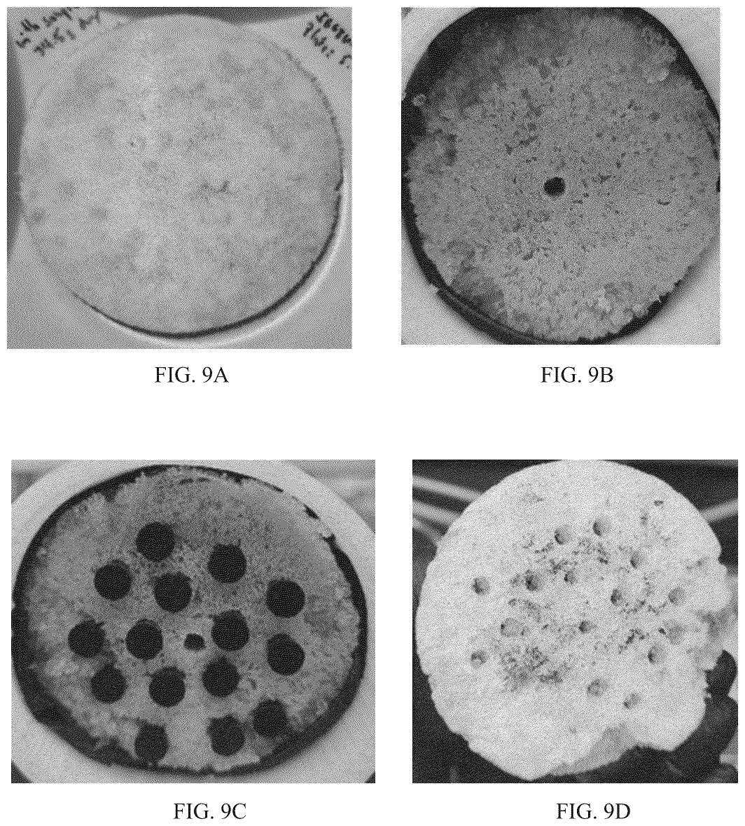

As an example, FIG. 9A shows a photograph of a hygroscopic polymer composite body comprising a functionalized chitosan-based ionomeric material and a polyisocyanurate-based support polymer material including a microporous matrix. As another illustrative example, FIG. 9B shows a photograph of a hygroscopic polymer composite body comprising a poly-DADMAC-based ionomeric material incorporating a calcium chloride salt and a polyisocyanurate-based support polymer material including a microporous/microporous matrix and a central templated pore or void.

FIG. 9B-D shows photographs of a hygroscopic polymer composite body comprising a poly-DADMAC-based ionomeric material incorporating a calcium chloride salt and a polyisocyanurate-based support polymer material. To illustrate possible variations in forming larger voids or pores in a hygroscopic polymer composite body, FIG. 9B shows a single central pore for airflow through the hygroscopic polymer composite body, FIG. 9C shows formation of multiple pores or voids via a templating pin (black) and FIG. 9D shows a hierarchically porous hygroscopic polymer composite body comprising larger pores or voids after template pin removal.

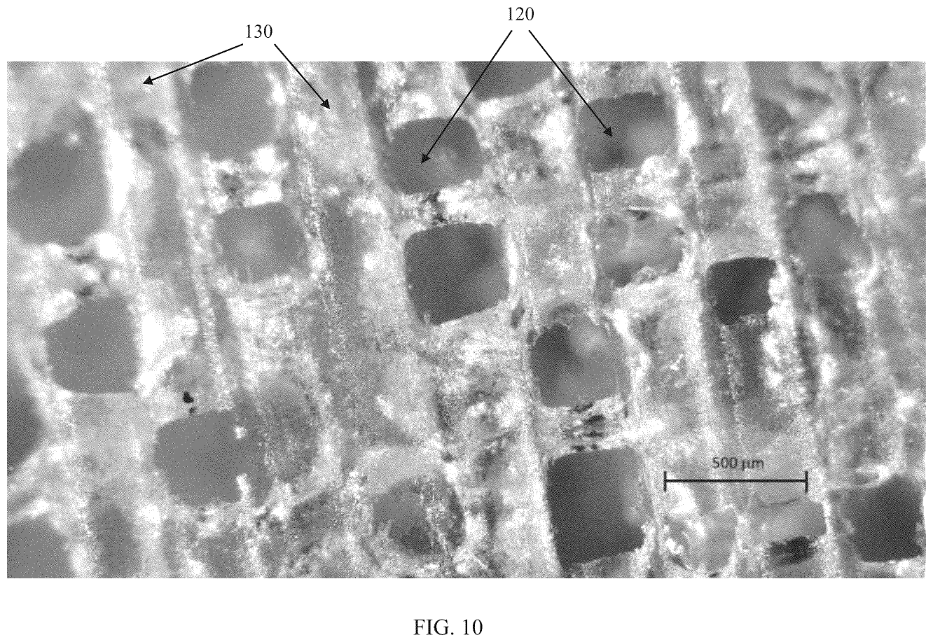

FIG. 10 depicts a magnified photograph of a hygroscopic polymer composite body comprising a functionalized chitosan-based ionomeric material and a polyisocyanurate-based support polymer material. As visible in FIG. 10, the support polymer material 130 is a polymeric foam formed around the ionomeric material 120 to support volume changes upon water uptake and release (e.g., from transition to a swelled to contracted state).

It can be preferable to minimize the density or weight of the porous hygroscopic composite, for example by modifying the composition and/or tuning the pore structure. In various embodiments, a porous hygroscopic composite exhibits a density between 50-800 kg/m³, between 100-500 kg/m³, less than 800 kg/m³, less than 500 kg/m³, less than 400 kg/m³ and/or less than 200 kg/m³. In an example, a lower density threshold could be set by determining a minimum composite density based on the water sorption or retention capacity (e.g., from an isotherm measurement) for a minimum desired water mass uptake or sorption capacity for a particular use or application. For example, the support polymer content can be modified between 20-50 wt. % to set the density from 450 kg/m³ to 150 kg/m³.

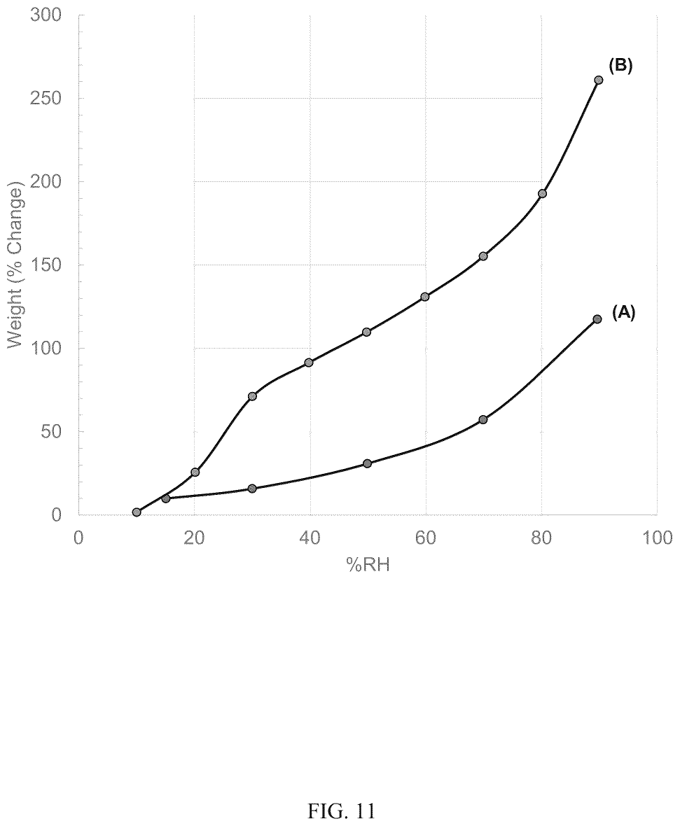

Water uptake rate and capacity of the composite can be modified based on the composite formulation. The ionomeric material can rapidly absorb and retain a large amount of water, even exceeding its own weight (e.g., minutes to hours depending on the specific formulation, particle size, pore structure, thickness, etc.). However, there may be applications or uses where the formulation of the composite can be modified to include a hygroscopic or deliquescent salt, for example to increase its water storage capacity. As an illustrative example, FIG. 11 shows water sorption isotherm measurements at 25° C. for A) a 2 mol % crosslinked poly-DADMAC ionomeric material and B) the same poly-DADMAC ionomeric material incorporating 80 wt. % calcium chloride. The isotherm plots show equilibrated water contents of the composite at a particular relative humidity of the surrounding environment. A contracted state of the composite can be defined as a state having a lower or reduced content of water (e.g., at a lower % RH on the isotherm of FIG. 11) relative to a swelled state defined by having a higher water content (e.g., at a higher % RH on the isotherm of FIG. 11).

As shown in FIG. 11, the inclusion of a hygroscopic salt can double or even triple the water storage capacity of the composite while maintaining mechanical integrity without weeping. Even at high amount of calcium chloride in the composite, it is notable that the composite is able to retain the equilibrated water content (via the three-dimensional polymer network of the ionomeric material and support polymer material) without leakage, weeping, liquid water formation or loss, even at high equilibrated water contents. In some applications, it may be preferable to set an upper limit of the hygroscopic salt content, for example, hygroscopic salt content in the composite can be set at or below 60 wt. % for systems or devices which may be exposed to greater than 90% RH.

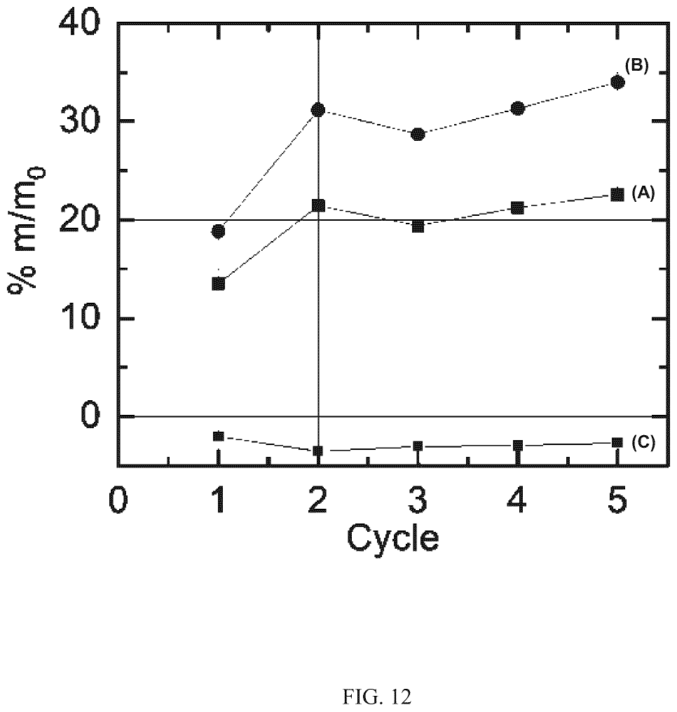

Hygroscopic polymer composites of the present technology can retain a large amount of water in a highly reversible manner such that the composite body does not leak, weep or lose liquid water (and/or hygroscopic salt solution if present) upon water vapor sorption/desorption cycling across range of ambient conditions. To illustrate water sorption capacity for an exemplary poly-DADMAC composite described herein, FIG. 12 shows reversible water vapor sorption cycling at 60% RH and 25° C. for (A) a hygroscopic polymer composite relative to (B) its constituent ionomeric material and (C) its constituent support polymer material. The hygroscopic polymer composite of FIG. 12(A) shows water sorption capacity close to that of the ionomeric material alone shown in FIG. 12(B) while having characteristic mechanical integrity provided by the support polymer material.

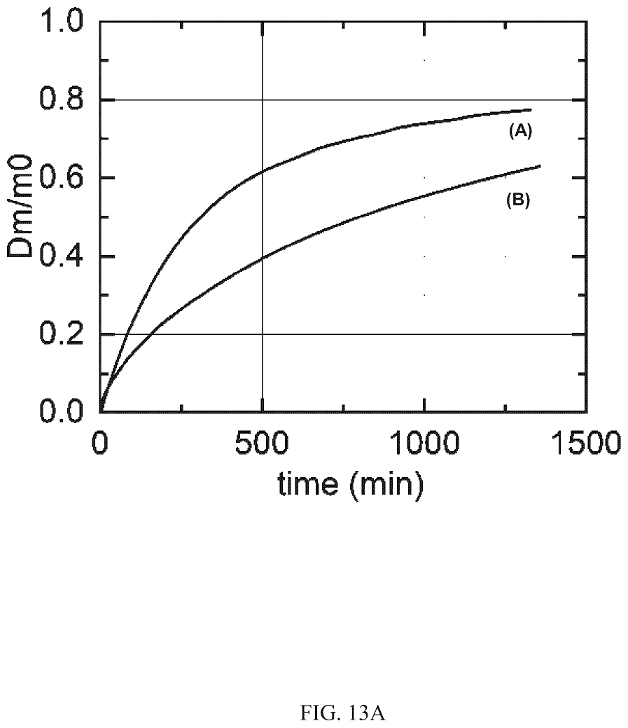

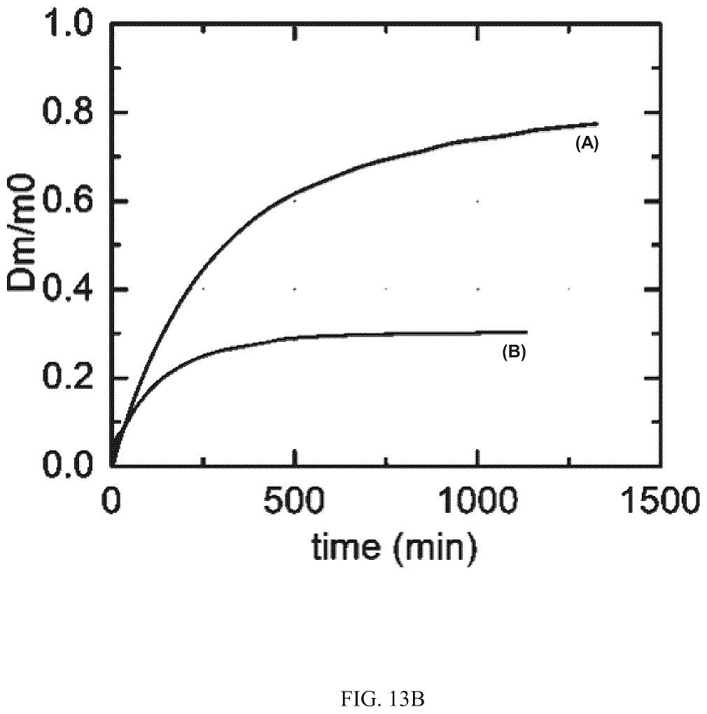

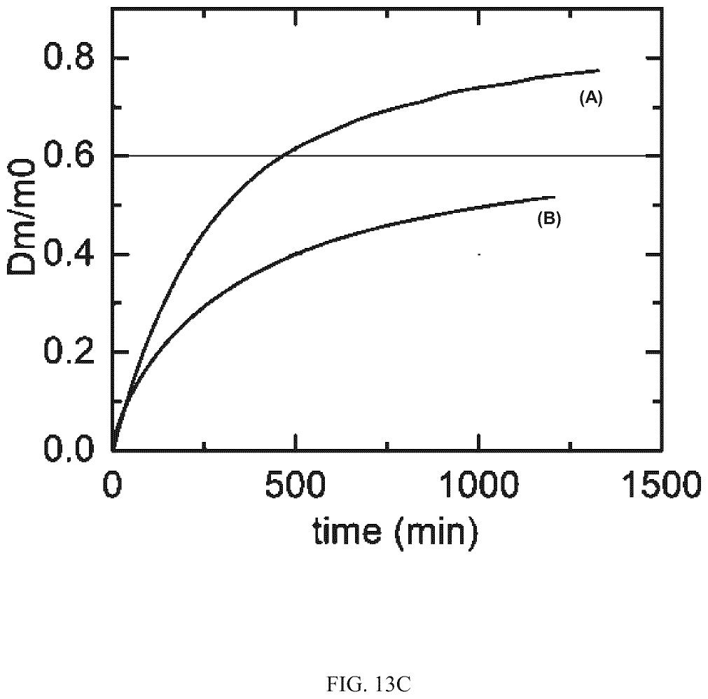

The reversible water sorption capacity and cycling behavior can be tuned depending on application and use of the composite by tuning the composition of the ionomeric material, support polymer and hygroscopic salt (if present). For example, hygroscopic polymer composites of the present technology can exhibit reversible water sorption capacities above 10%, 20%, 40% or 60% by mass of the composite (m/m0) at 60% RH and 25° C. depending on the selected composition. To illustrate tunability in sorption/desorption cycling, FIG. 13A shows water vapor sorption or water uptake at 60% RH and 25° C. for an exemplary hygroscopic polymer composite comprising a hygroscopic salt incorporated within a poly-DADMAC ionomeric material supported by (A) 20 wt. % polyisocyanurate foam support polymer and (B) 30 wt. % polyisocyanurate foam support polymer. A higher amount of ionomeric material (and hygroscopic salt if present) relative to the support polymer in the composite can increase the water sorption capacity, however there can be a trade off in mechanical integrity. Therefore, the composition of the composite can be varied depending on the desired application, use, ambient environment and/or cycle life.

As another example to illustrate tunable water sorption characteristics of the composites described herein, FIG. 13B shows water vapor sorption or water uptake at 60% RH and 25° C. for an exemplary hygroscopic polymer composite (A) with a calcium chloride hygroscopic salt and (B) in the absence of a hygroscopic salt (i.e., a composite comprising a poly-DADMAC ionomeric material and a polyisocyanurate foam support polymer). As yet another example to illustrate composite compositional tunability, FIG. 13C shows water vapor sorption or water uptake at 60% RH and 25° C. for an exemplary hygroscopic polymer composite (A) with 20 wt. % support polymer (polyisocyanurate foam) and 60 wt. % hygroscopic salt (calcium chloride) and (B) with 40 wt. % support polymer (polyisocyanurate foam) and 40 wt. % hygroscopic salt (calcium chloride) incorporated into an ionomeric material (poly-DADMAC).

To provide additional characteristic properties of composite described herein, a swelling ratio of the composite can be defined as a sample weight at a given time, % RH or water content divided by the initial dried sample weight. As a result of the composite architecture including a porous support polymer material matrix supporting volume changes of the ionomeric material during water sorption cycling, composites of the present technology can exhibit swelling ratios less than 0.01%, 0.1%, 0.5%, 1% and/or 5% by weight when exposed to 90% RH for at least 12 hours, 24 hours, 48 hours and/or 72 hours. As another exemplary characteristic of composites of the present technology, composites can lose (e.g., leak, weep, elute) less than 0.01%, 0.1%, 0.5%, 1% and/or 5% by weight of liquid water and/or hygroscopic salt solution (if present) at 90% RH for at least 24 hours, 48 hours and/or 72 hours. However, composites of the present technology can be designed and have exhibited no weeping or salt migration upon cycling.

The mechanical strength of the hygroscopic polymer composite can be tuned based on end use and/or ambient environment at installation location. The support polymer material can be provided as or comprise a semi-rigid or rigid polymeric foam. In an example, the support polymer material can exhibit an elastic modulus between 60 to 700 MPa, between 60 to 700 MPa, between 68 to 690 MPa and/or greater than 60 MPa. Furthermore, the support polymer material can exhibit a compression strength between 100 to 1000 kPa, between 100 to 200 kPa, between 110 to 172 kPa and/or greater than 100 kPa.

Hygroscopic polymer composite of the present technology can exhibit mechanical stability such that they are capable of being free-standing, self-standing or self-supporting in both dry and wet conditions. While the water vapor permeable polymer material of the hygroscopic polymer composite can provide mechanical stability upon sorption cycling and thus act as a support polymer, some compositions can comprise mechanical reinforcement materials such as reinforcing fibers like carbon fiber, fiber glass, woven fibers, mats and/or the like.

This disclosure is directed to a new class of hygroscopic polymer composites having distinctive water vapor sorption and desorption properties that provide for stable performance without weeping across a range of ambient conditions. As such, these materials can be deployed in wide ranging applications such as thermal management or passive cooling systems, humidity regulation systems, water-from-air generation systems and/or dehumidifiers. The materials and compositions of the present technology can be deployed in both established and entirely new applications that may benefit from effective thermal insulation, passive cooling, thermal regulation, mechanical strength and/or stable and reversible water vapor sorption and desorption characteristics.

Various illustrative applications for the hygroscopic polymer composites are provided herein such as coatings for passive cooling of solar panels and water generation systems. However, the hygroscopic polymer composites of the present technology can be deployed in many other systems that could benefit for reversible water sorption/desorption without weeping across a range of ambient conditions without departing from the spirit and scope of the disclosure.

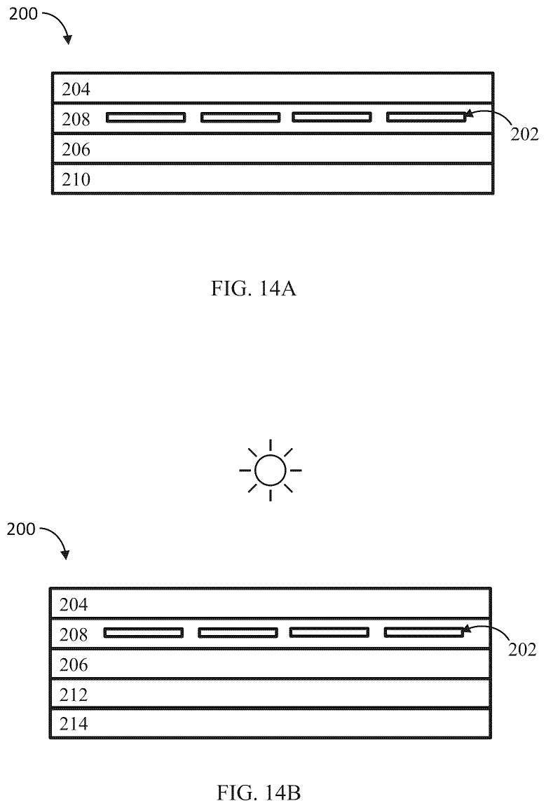

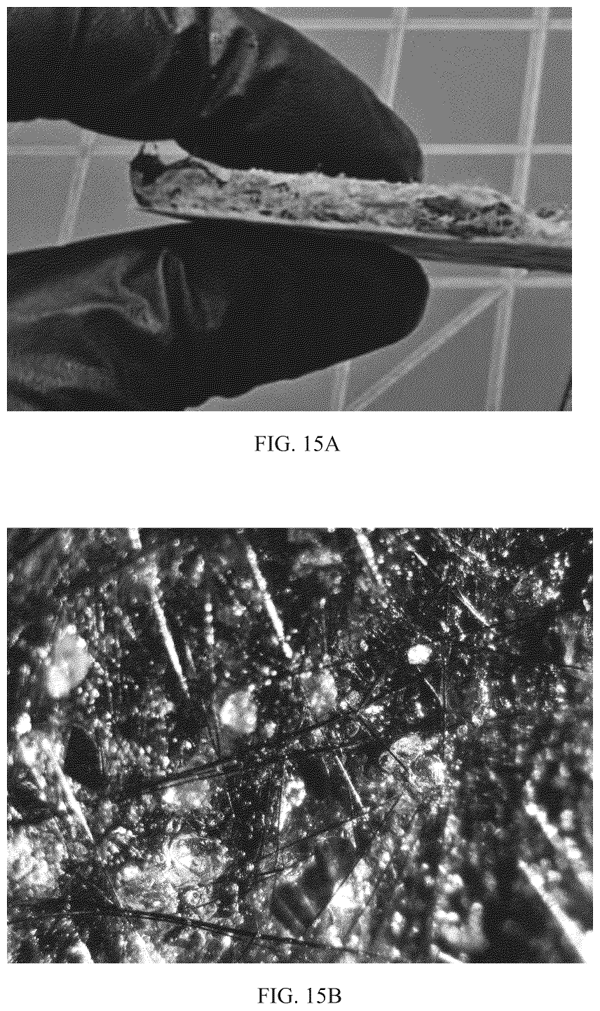

FIG. 14A illustrates a cross-sectional view of a solar panel 200 comprising a plurality of solar cells 202. Each solar cell can comprise a front side that faces the sun during a daytime operation to convert solar radiation impinging thereon into electrical energy and heat, and a backside opposite the front side. The solar panel 200 can include a transparent cover 202 over or above the front sides of the solar cells 202 that can comprise glass or transparent polymer material. Backsheet 206 can be provided on or towards the backsides of the solar cells 202. An encapsulant 208 can bond the solar cells 202, the transparent cover layer 204 and the backsheet 206 together in a protective package. Solar panel 200 can further comprise a tile or coating 210 at a back side of the panel comprising a hygroscopic polymer composite of the present technology. Water evaporated by the hygroscopic polymer composite of tile or coating 210 can improve efficiency of the solar panel as latent heat of water evaporation can be utilized to absorb heat generated by the solar panel during operation (e.g., during a daytime operation), thereby decreasing its operating temperature.

The hygroscopic polymer composite tile or coating 210 can comprise an ionomeric material and a water vapor permeable polymer material, and the water vapor permeable polymer material can support a volume change of the ionomeric material (and a hygroscopic salt, if present) between a first state (e.g., contracted or low water content state) and a second state (e.g., a swelled or high water content state). The hygroscopic polymer composite tile or coating 210 can receive heat generated by the solar panel during a daytime operation such that water is evaporated from the hygroscopic polymer composite tile or coating 210 to the ambient environment upon transition from the swelled state to the contracted state.

In some implementation, hygroscopic polymer composite tile or coating 210 can comprise additive(s) to increase thermal conductivity. For example, various fillers, fibers, or other additives increasing thermal conductivity could be provided such as metal powders, particulates, microparticles or nanoparticles (e.g., aluminum, copper, silver), metal oxides (e.g., aluminum oxide, zinc oxide, boron nitride), carbon-based materials (e.g., graphite, graphene, carbon nanotubes, carbon fibers), ceramic materials (e.g., aluminum nitride, silicon carbide, boron nitride), polymer fibers or whiskers (e.g., polyaramids, polyesters), or combinations thereof. The amount of thermal conductivity additive can range from 2 to 50 wt. %, 5 to 40 wt. % in the composite depending on the desired application. As an illustrative application, hygroscopic polymer composites of the present technology can be used to cool a photovoltaic panel so as to decrease operating temperature and increase efficiency. In such applications, it can be preferable to include thermally conductive additive(s) in an amount on a higher end of the range, for example greater than 10 wt. % in the composite, greater than 20 wt. % in the composite and/or greater than 30 wt. % in the composite.

FIG. 14B shows another example where solar panel 200 comprises a multilayer coating on backsheet 206. An inner layer 212 can contact or be applied to the solar panel backsheet 206 and an outer layer 214 can contact or be applied to the inner layer 212 such that outer layer 214 is exposed to the ambient environment. The outer layer 214 can comprise the ionomeric material (and a hygroscopic salt if present) and the water vapor permeable polymer material such that the outer layer 214 absorbs water vapor from ambient air during a nighttime period, and receives heat generated by the solar cells 202 during a daytime operation. In one example, the inner layer 212 can have a greater thermal conductivity than outer layer 214. The outer layer 214 can receive, via inner layer 212, heat generated by the solar cells 202 during the daytime operation to decrease the operating temperature of the solar panel 200, thereby increasing operating efficiency of the solar panel. In such an implementation, the inner layer 212 can comprise a thermally conductive material. The inner layer 212 can comprise a polymeric material including fillers, fibers, or other additives to increase its thermal conductivity. Non-limiting examples of fillers, fibers, or other additives increasing thermal conductivity include metal powders, particulates, microparticles or nanoparticles (e.g., aluminum, copper, silver), metal oxides (e.g., aluminum oxide, zinc oxide, boron nitride), carbon-based materials (e.g., graphite, graphene, carbon nanotubes, carbon fibers), ceramic materials (e.g., aluminum nitride, silicon carbide, boron nitride), polymer fibers or whiskers (e.g., polyaramids, polyesters), or combinations thereof. The inner layer 212 and outer layer 214 can comprise similar polymeric materials (e.g., both layers can comprise the hygroscopic polymer composite material). In other implementations, the inner layer 212 and outer layer 214 can comprise different polymeric materials (e.g., the inner layer 212 comprises an epoxy-based thermally conductive adhesive comprising conductive fillers and the outer layer 214 comprises a hygroscopic polymer composite material of the present technology).

Solar or photovoltaic (PV) panels commonly comprise an outer backsheet layer (e.g., layer 206) comprising fluoropolymers (e.g., polyvinyl fluoride (PVF), polyvinylidene fluoride (PVDF) and often core or inner layers of polyethylene terephthalate (PET), ethylene vinyl acetate (EVA). EVA is also commonly used as an encapsulant, for example as encapsulant layer 208.

Solar or photovoltaic (PV) panels can degrade over time due to various factors associated with their operation in the field including prolonged exposure to UV rays that can cause degradation of panel materials including the encapsulant and backsheet as well as temperature cycling resulting in constant expansion and contraction leading to panel stresses that can cause microcracks and/or delamination in encapsulation and backsheet layers. Furthermore, solar cells can degrade over time due to environmental factors, potential-induced degradation (PID) or other electrical degradation mechanisms that can lead to corrosion, increased resistance, or shunt currents that can reduce the overall panel performance over time.

As an illustrative example, FIG. 15A shows a photograph of a hygroscopic polymer composite formed as a layer (e.g., tile or coating that can be applied to a rear surface of a solar cell or panel) comprising a polyDADMAC ionomeric material and a PEBA-based water vapor permeable polymer material dispersed on a carbon fiber reinforcing material. FIG. 15B depicts a magnified photograph of the hygroscopic polymer composite layer comprising polyDADMAC ionomeric material and PEBA-based water vapor permeable polymer material dispersed on the carbon fiber material. For reference, carbon fibers in the composite of FIG. 15B have an average diameter of 10 micron (μm). The carbon fiber material can provide mechanical stability of the layer, for example due to water sorption (i.e., during nighttime) and desorption (i.e., during daytime) cycling to passively cool a PV cell or panel, thereby increasing power output of the PV cell or panel.

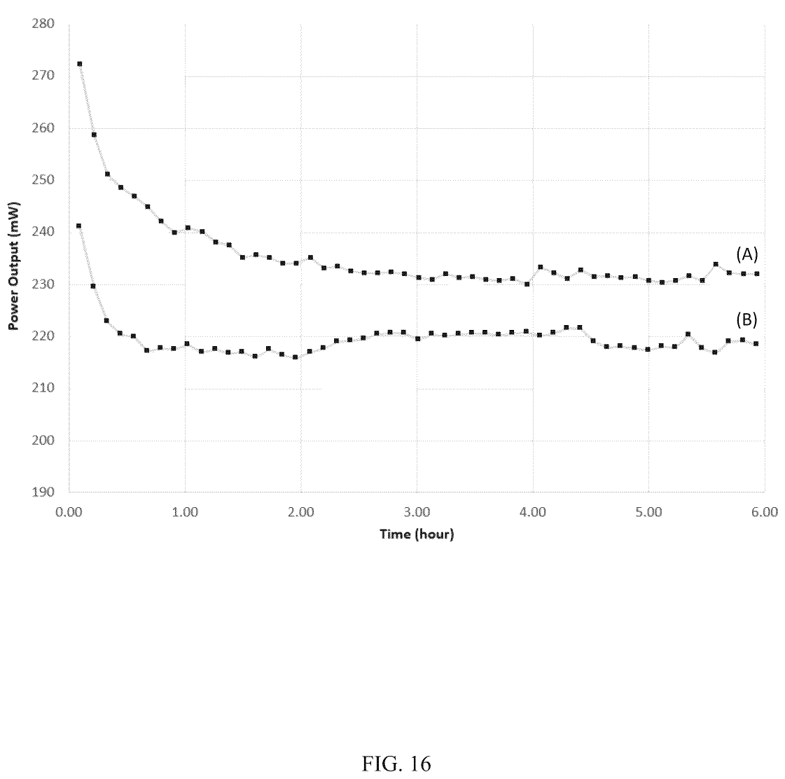

To experimentally demonstrate the PV cooling functionality for an exemplary composite of the present technology, FIG. 16 shows power output in milliwatts (mW) for 18 cm² crystalline silicon solar cells with tested at 1000 W/m² irradiance over 6 hours at room temperature. Solar cell (A) comprises a hygroscopic polymer composite of the present technology adhered to its rear surface and is compared to a similar solar cell (B) without any back side coating. Over the course of the 6-hour test, solar cell A produces approximately 7% more energy than solar cell B due to a cooling effect wherein water in the hygroscopic polymer composite rear coating (e.g., water captured during a prior night cycle) is evaporated via heat produced by the solar cell during solar irradiance. As such, this experiment shows the capability of hygroscopic polymer composites of the present technology to improve efficiency of solar cells and panels as latent heat of water evaporation can be utilized to absorb heat generated during operation.

While a hygroscopic polymer composite layer, tile or coating can be applied to solar modules during manufacturing, there is an opportunity to improve performance of solar modules that have been operating in the field and degraded over time due to various degradation mechanisms. For example, a coating comprising hygroscopic polymer composites of the present technology can be provided or applied (e.g., via spray coating or roller coating rear surfaces of the solar panels such as the backsheet).

In some implementations, adhesion of the applied coating can be improved, for example when applying to a solar module having been aged or operated for an extended period of time, by removing a top or surface layer of a backsheet in advance of applying the hygroscopic polymer composite coating. For example, mechanical methods (e.g., sanding, abrasive blasting), chemical stripping (e.g., solvents to dissolve or soften a top layer), thermal methods (e.g., heat gun, laser) and/or ozonolysis stripping can be employed. In cases where an outer or rear layer of a solar panel has a poor thermal conductivity or poor adhesion for applying the hygroscopic polymer composite coating (e.g., due to chemistry and/or aging), an inner or intermediate layer can be applied in advance of the hygroscopic polymer composite coating. For example, inner layer 212 can be provided to improve adhesion of the hygroscopic polymer composite coating on the backsheet 206.

In another exemplary application, hygroscopic polymer composites described herein can be used in water generation devices as a sorbent material that captures or retains (e.g., absorbs, adsorbs) water vapor from ambient air) under a first condition (e.g., nighttime) and releases the absorbed water (e.g., via a temperature swing, a humidity swing, a pressure swing) under a second condition (e.g., daytime via solar thermal heat). The released water vapor can then be condensed (e.g., by a water generation system condenser) to generate liquid water from atmospheric humidity. The reversible hygroscopic properties of hygroscopic polymer composites without weeping enable regeneration of the material such that water can be consistently produced for a user (e.g., as drinking water for user consumption). Accordingly, various embodiments relate to systems and methods for generating water from air with hygroscopic polymer composites.

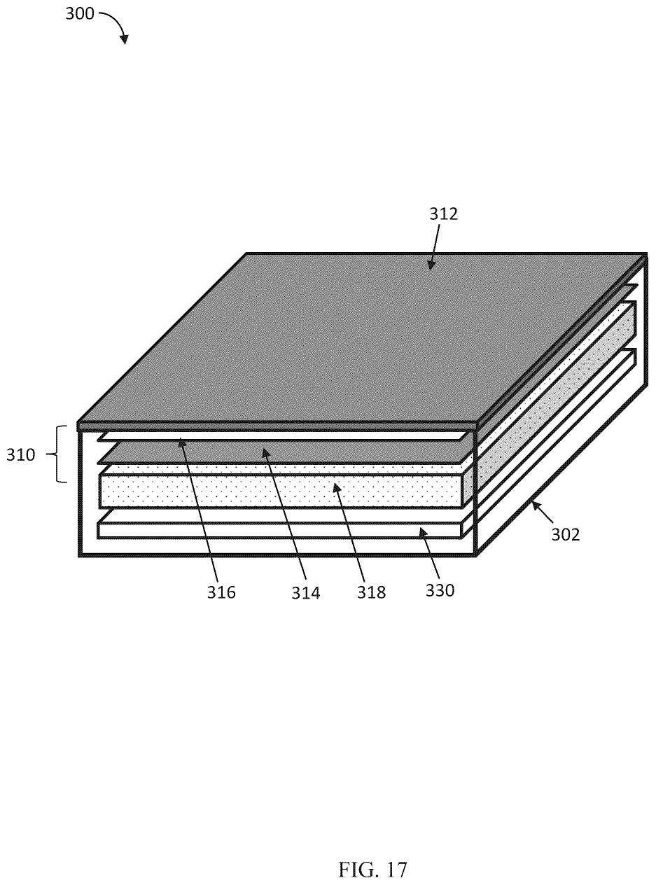

FIG. 17 illustrates a perspective cross-sectional view of a water generation system 300 comprising a hygroscopic polymer composite. The water generation system 300 can generate liquid water from a process gas containing water vapor, for example ambient air at atmospheric temperature and pressure. System 300 comprises a solar thermal unit, for example configured as a top cover and/or glazing layer(s) 312 coupled to a housing 302 such that an outer top surface is exposed to the ambient environment to collect solar radiation. System 300 can optionally include a solar power unit, power generation unit such as a photovoltaic (PV) panel or layer 314. In some embodiments, a water generation system can further comprise at least one interstitial layer (e.g., 316) below a top cover layer (e.g., 312) for improving solar radiation collection.

Water generation systems of the present disclosure convert solar insolation to thermal energy by transferring energy from sunlight to a regeneration gas, heat absorbing gas or working gas (e.g., air in a closed loop) that flows through the water generation system. In some embodiments, the water generation system converts solar insolation to both thermal and electrical energy, for example via a solar unit including one or more glazing layer(s) and photovoltaic layer(s).

The top cover layer 312 comprises an outer surface exposed to ambient air and an inner surface opposite from the outer surface. The top cover or glazing layer can include a transparent material (e.g., glass) allowing solar radiation to pass into the interior of the water generation system 100. In some embodiments, the top cover layer can comprise one or more photovoltaic panels including PV cells for converting solar insolation to electrical energy. Furthermore, one or more interstitial layers can comprise an assembly including one or more photovoltaic (PV) panels or layers for converting solar insolation to electrical energy, one or more glazing layers (e.g., transparent layers, glass layers) or a combination thereof. In some embodiments, optional interstitial glazing layers can be distinct layers from one or more photovoltaic layers (e.g., separated by a gap), such as depicted in FIG. 17 (i.e., interstitial glazing layer 316 is positioned above and spaced apart from photovoltaic layer 314). However, in other embodiments, an interstitial layer can be integrally formed or comprise both a glazing portion (e.g., glass) and a photovoltaic unit or portion (e.g., photovoltaic cells), in addition to other components (e.g., encapsulation materials, electrical wiring, and/or the like). In some embodiments, water generation systems of the present disclosure can comprise a photovoltaic panel or layer 314 below and spaced apart from top cover layer 312 without any intervening layer(s).

In some embodiments, the water generation systems can be configured as a glazed or unglazed solar thermal collector(s) to convert radiant solar energy into thermal energy, and in turn, heat the porous hygroscopic composite and/or a regeneration gas. Furthermore, some water generation systems can include hybrid solar collectors, or photovoltaic thermal solar collectors that convert solar radiation into both thermal and electrical energy such that the generated heat is transferred to the porous hygroscopic composite and/or regeneration gas and the generated electricity powers the components of the water generations system (e.g., fan(s), compressor(s), controller(s) and/or the like).

Water generation system 300 comprises a sorption unit, body or layer 318 that includes a hygroscopic polymer composite of the present technology. The sorption layer 318 is configured to capture (e.g., adsorb, absorb) water vapor from a process gas (e.g., ambient air at atmospheric pressure) upon flow across and/or therethrough, for example during a sorption cycle (e.g., nighttime hours). Furthermore, the sorption layer 318 can be configured to transfer water vapor heat and/or heat to a regeneration or working gas during an unloading, release or desorption operational cycle.

The sorption layer can be configured to receive heat from at least one thermal source, for example a regeneration gas, solar insolation, a photovoltaic cell, a heater, a heat exchanger, a condenser of a vapor-compression refrigeration unit and/or the like. Furthermore, the regeneration gas can accumulate heat, and/or water vapor when comprising a hygroscopic material, upon flowing across or through the sorption layer. In FIG. 17, sorption layer 318 is positioned below and spaced apart from glazing layer 312 and interstitial photovoltaic layer 314, however other configurations are also possible without departing from the spirit and scope of the disclosure.

As depicted in FIG. 17, water generation system 100 further comprises a heat exchange assembly 330 for increasing the relative humidity and/or the partial pressure of water vapor in the regeneration gas to drive condensation of water vapor from the regeneration gas during the desorption mode or cycle. The heat exchange assembly 330 can be configured to reduce the temperature of the regeneration gas by rejecting heat to ambient and/or another heat absorbing fluid, e.g., a refrigerant. The heat exchange assembly 330 can be configured as a single unit provided as an assembly of components (e.g., including all components of a refrigeration unit or circuit) or be a component of a larger refrigeration or heat transfer unit or cycle (e.g., including some components of a refrigeration circuit, a heat exchanger and/or the like).

In one example, the heat exchange assembly 330 comprises a refrigeration unit or circuit configured to circulate a refrigerant in a closed refrigerant loop including a refrigerant evaporator (e.g., configured as part of or integrated with a liquid water condenser), a refrigerant compressor, a refrigerant condenser, and a refrigerant expansion device (e.g., expansion valve or capillary) via refrigerant piping or tubing. In some implementations, the heat exchange assembly (e.g., 330) comprises a refrigeration circuit integrated with a sorption unit (e.g., 318) such that a refrigerant condenser of the refrigeration circuit transfers heat, i.e., acts as a thermal source, to the sorption layer (e.g., 318) during a desorption mode or cycle. Furthermore, the refrigerant evaporator of a refrigeration circuit can be configured as part of or integrated with a liquid water condenser, i.e., act as a heat exchanger transferring heat from the regeneration gas (and/or latent heat form condensation of water vapor from regeneration gas) to refrigerant circulating through refrigerant evaporator of the refrigeration circuit.

In various implementations, heat exchange assembly 330 comprises liquid water condenser configured to provide a high surface area for heat transfer for condensation of water vapor from the regeneration gas with minimal pressure drop upon flow across or therethrough. In one example, a liquid water condenser can comprise a heat sink and/or heat transfer surfaces (e.g., heat dissipating surfaces, fins, ridges, ribs, protrusions, clamshell, passive heat sink and/or the like) to reject heat from the regeneration gas to the ambient environment. In some embodiments, the heat exchange assembly 330 and/or liquid water condenser can form an outer portion of the housing 302 so as to reject heat to the ambient environment. In other embodiments, the heat exchange assembly can be located entirely within the housing.

In many embodiments the sorption unit or layer(s) (e.g., 318) comprise or are formed of a hygroscopic polymer composite layer, material, composite, body or assembly configured to capture and release water vapor upon exposure to a process gas (e.g., ambient air) and can have various compositions and structures. The sorption unit or layer(s) (e.g., 318) can be configured as one or more hygroscopic polymer composite body or layer that can be porous to allow airflow therethrough. The ‘porous’ or ‘porosity’ term used herein in regards to a water generation system can describe a flow-through implementation, as opposed to flow-over or flat plate implementation of a sorption unit. While flow-over or flat plate implementations could be employed (e.g., via coating hygroscopic polymer composite on a surface), it can be preferable to keep the boundary layers small with a high degree of percolation for example as can be provided in porous flow-through bodies, units or layers.

A hygroscopic polymer composite, composite assembly or layer can be further configured to absorb thermal energy (e.g., radiative solar thermal energy) and release captured water vapor to a working or regeneration gas, for example during a desorption/release operational mode or cycle. In one example, a hygroscopic polymer composite can be arranged within a flow distributor, such as but not limited to a lattice structure, top and bottom rigid porous plates, inter-corrugated fluidic channels, interdigitated fluidic channels, and/or woven and fiber meshes to sustain back pressure and distribute the flow. A hygroscopic polymer composite of the present technology can be further configured as a composite assembly such that its structure provides the system with structural properties, pressure drop, flow paths, and/or thermal properties.

The disclosure also provides for shaped or molded composites wherein the hygroscopic polymer composite is produced or formed as a block or panel that can be deployed in various systems or structures where high mechanical strength, highly effective thermal regulation properties and/or stable water vapor sorption/desorption characteristics without weeping are desired, for example in water-from-air generation systems, dehumidifiers, thermal management systems, humidity regulation systems, passive cooling and/or the like. The hygroscopic polymer composites can be provided in any number of form factors of various sizes and thicknesses. The hygroscopic polymer composites have the advantage of being easy to be formed or molded into the desirable form factor, handled, transported and even cut or resized (e.g., with a saw), for example at an installation or deployment site.

Not to be bound by any particular theory, but hygroscopic polymer composites described herein can provide a thermal energy buffering effect via vaporization of water as latent heat (e.g., along the diurnal cycle where ambient temperature and humidity varies over a 24 hour period) such that heat is released upon sorption of ambient moisture (e.g., during a nighttime condition with lower ambient temperature and/or greater ambient relative humidity) and heat is consumed during water vapor desorption (e.g., during a daytime condition with higher ambient temperature and/or lower ambient relative humidity).

The hygroscopic polymer composites of the present technology can be employed in various latent thermal energy storage applications to store and release thermal energy via a phase change process involving the absorption and desorption of water vapor by the hygroscopic polymer composite. During a sorption, uptake, or “charging” operation, the hygroscopic polymer composite undergoes a sorption process to absorb and retain moisture, thereby storing thermal energy as latent heat. During a storage operation or state, the hygroscopic polymer composite effectively stores the latent heat energy and moisture without weeping. During a desorption, release, or “discharging” operation, the hygroscopic polymer composite releases thermal energy and moisture as water vapor, for example via exposure to a drier environment and/or heating to release the stored latent heat. This process can provide a source of thermal energy for various applications, and the hygroscopic material returns to its original dry state.

These hygroscopic polymer composites offer an innovative approach to efficient and sustainable energy management that can be used in applications where temperature and/or humidity regulation are critical. Depending on the end use or application, the hygroscopic polymer composites can be configured to improve interaction with the ambient environment and/or facilitate sorption and desorption of ambient humidity. In various embodiments, the hygroscopic polymer composites can be sprayed, coated, formed or molded into bodies or layers that can include larger air channels or voids (e.g., via a templating mold that is removed after polymerization, setting and/or curing). In one example, hygroscopic polymer composites can be coated or sprayed onto a surface. In another example, hygroscopic polymer composites can be formed into a porous flow-through body, for example having a pore structure with a range of pore sizes (e.g., multimodal or bimodal pore size distribution where smaller voids or pores are formed upon synthesis and/or larger air voids or channels are formed via a template mold). In many examples, smaller pore diameters can range from 0.1-5 mm whereas larger channel or pore diameters can range from about 5 mm to 10 mm.

Various methods can be used to manufacture or produce hygroscopic polymer composites of the present technology including but not limited to polymerization, co-polymerization, wet mixing, dry mixing, blending, spray coating, impregnation, incipient wetness methods, drying, heating, curing, autoclaving, templating, molding or similar derivate methods and combinations thereof.

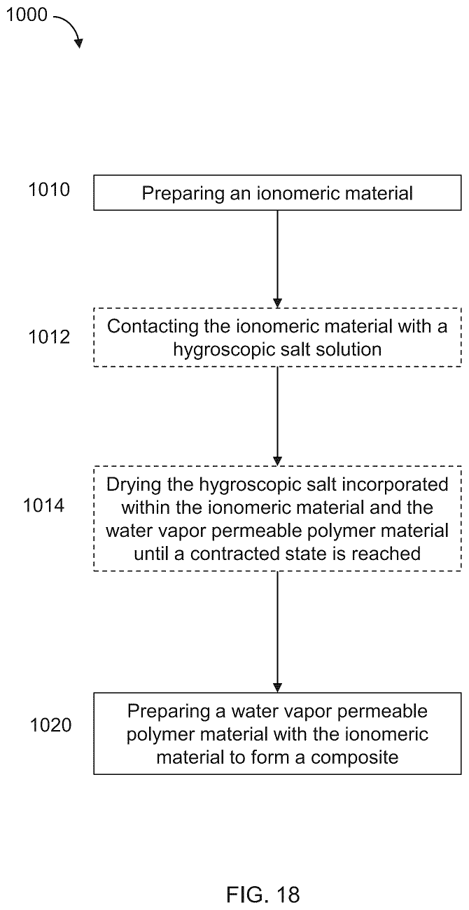

Referring to FIG. 18, flowchart 1000 depicts a method of producing hygroscopic polymer composite in accordance with an embodiment of the present disclosure. The method depicted in the disclosed flowcharts are merely exemplary and are not limited to the embodiments presented herein. The disclosed flowchart(s) can be employed in many different embodiments or examples not specifically depicted or described herein. In some embodiments, the operations or activities of the method flowcharts are performed in the order presented. In other embodiments, the operations or activities of the method flowcharts can be performed in any other suitable order. In still other embodiments, one or more of the operations or activities in the method flowcharts can be combined or skipped. Furthermore, operations or activities with dashed outlines represent optional operations or activities.

At activity or operation 1010, the method of manufacturing a hygroscopic polymer composite comprises preparing an ionomeric material.

For example, operation 1010 can comprise polymerizing a monomer of a water vapor permeable or support polymer material to form a porous network or foam around the hygroscopic salt-incorporated ionomeric material in a super-swelled state.

At optional activity or operation 1012, the method comprises contacting the ionomeric material with a hygroscopic salt solution until a swelled or super-swelled state is reached.

At optional activity or operation 1014, the method comprises drying the hygroscopic polymer composite comprising the hygroscopic salt incorporated within a crosslinked network of the ionomeric material and the water vapor permeable polymer material. At operation 1014, drying the hygroscopic salt-incorporated ionomeric material to an equilibrated swelled or contracted state within the water vapor permeable polymer material can form air-permeable pores within the hygroscopic polymer composite.

At activity or operation 1012, the method comprises an activity or operation of preparing a water vapor permeable polymer material to support the ionomeric material within a porous matrix of the water vapor permeable polymer material such that the porous matrix of the water vapor permeable polymer material supports a volume change of the ionomeric material between a contracted state and a swelled state.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one embodiment or may relate to several embodiments.

The claims are not intended to include, and should not be interpreted to include, means-plus-or step-plus-function limitations, unless such a limitation is explicitly recited in a given claim using the phrase(s) “means for” or “step for,” respectively. The term “about” or “substantially,” as used herein, is intended to encompass minor deviations rather define an exact value.

1. A composite comprising:
an ionomeric material having an ionized polymeric matrix to retain an equilibrated water content; and,
a water vapor permeable polymer material;
wherein the water vapor permeable polymer material supports a volume change of the ionomeric material between a contracted state having a first equilibrated water content and a swelled state having a second equilibrated water content, the second equilibrated water content being greater than the first equilibrated water content.

2. The composite of claim 1, further comprising:
a reinforcement material to support a volume change of the ionomeric material or both the ionic material and the water vapor permeable polymer material between the contracted state and the swelled state.

3. The composite of claim 1, wherein the water vapor permeable polymer material comprises a porous matrix to facilitate water vapor permeation and provide a rigid framework to support the volume change of the ionomeric material between the contracted state and the swelled state.

4. The composite of claim 1, wherein the water vapor permeable polymer material is an elastomer to facilitate water vapor permeation and exhibits an elastic volume change between the contracted state and the swelled state.

5. The composite of claim 1, wherein the ionomeric material has a degree of crosslinking between 1-5 mol %.

6. The composite of claim 1, further comprising a hygroscopic salt incorporated within an ionized polymeric matrix of the ionomeric material.

7. The composite of claim 6, wherein the hygroscopic salt-incorporated ionomeric material is supported within the water vapor permeable polymer material; and, wherein the composite retains the equilibrated water content absorbed by the hygroscopic salt-incorporated ionomeric material within the water vapor permeable polymer material.

8.-10. (canceled)

11. The composite of claim 6, wherein the hygroscopic salt is present in the amount of 5 to 60 weight % of the ionomeric material.

12.-13. (canceled)

14. The composite of claim 6, wherein the hygroscopic salt comprises calcium chloride, calcium bromide, magnesium chloride, ammonium chloride, lithium bromide, lithium chloride, zinc bromide, sodium bromide, lithium iodide, sodium iodide, potassium iodide, potassium carbonate, potassium iodide, potassium sulfate, potassium acetate, zinc sulfate or a combination thereof.

15. (canceled)

16. The composite of claim 1, wherein the composite exhibits a reversible water sorption capacity above 20 weight % of composite mass at 60% RH and 25° C. in the absence of weeping.

17. The composite of claim 1, wherein the composite comprises air-permeable pores in the contracted state and the swelled state.

18. (canceled)

19. The composite of claim 1, wherein the water vapor permeable polymer material comprises a porous matrix, wherein the porous matrix of the water vapor permeable polymer material supports a volume change of the ionomeric material.

20. The composite of claim 1, wherein the water vapor permeable polymer material is provided as a foam configured to form around the ionomeric material in a super-swelled state such that air-permeable pores are present when the ionomeric material is in the contracted state, or in both the swelled state and the contracted state.

21. The composite of claim 1, wherein the water vapor permeable polymer material comprises a polyisocyanurate foam, a polyurethane foam, a polyimide foam, a phenolic foam, or a combination thereof.

22.-30. (canceled)

31. The composite of claim 1, wherein the ionomeric material comprises a polyamide, a polyacrylamide, a polysaccharide, a polycarbonate, a polyisocyanate, a polyepoxide, a polyurethane, a peptide, an alginate, or a combination thereof.

32. The composite of claim 1, wherein the ionomeric material comprises poly diallyldimethylammonium chloride (poly-DADMAC), a modified chitosan material, or a combination thereof.

33.-47. (canceled)

48. A layer comprising:
a hygroscopic polymer composite comprising an ionomeric material and a water vapor permeable polymer material, the water vapor permeable polymer material supporting a volume change of the ionomeric material between a contracted state and a swelled state, the swelled state having a greater water content than the contracted state;
wherein the hygroscopic polymer composite receives heat from a surface such that water is evaporated from the hygroscopic polymer composite to the ambient environment upon transition from the swelled state to the contracted state.

49. The layer of claim 48, wherein the layer is configured to receive heat generated by a solar panel during a daytime operation such that water is evaporated from the hygroscopic polymer composite to the ambient environment upon transition from the swelled state to the contracted state.

50. The layer of claim 48, wherein the layer comprises:
an inner layer contacting a backside of the solar panel;
an outer layer exposed to the ambient environment, the outer layer comprising the ionomeric material and the water vapor permeable polymer material,
wherein the outer layer absorbs water vapor from ambient air during a nighttime period; and,
wherein the outer layer receives, via the inner layer, heat generated by the solar panel during the daytime operation to decrease the operating temperature of the solar panel, thereby increasing operating efficiency of the solar panel.

51.-53. (canceled)

54. A solar panel comprising:
a plurality of solar cells, each of the solar cells comprising:
a front side that faces the sun during a daytime operation to convert solar radiation impinging thereon into electrical energy and heat, and
a backside opposite the front side;
a transparent cover over the front sides of the solar cells;
a backsheet on the backsides of the solar cells;
a layer comprising a hygroscopic polymer composite to receive heat generated by the plurality of solar cells during a daytime operation such that water is evaporated from the hygroscopic polymer composite to the ambient environment upon transition from a first state to a second state, the second state having a lower water content than the first state.

55.-58. (canceled)
